(19) United States
(12) Patent Application Publication
(10) Pub. No.: US 2026/0284557 A1
(43) Pub. Date: Sep. 24, 2026

(54) AXIAL FLOW SINGLE SPLIT FILTER

(71) Applicant: Atmus Filtration Inc., Nashville, TN (US)

(72) Inventors: Dhananjay KUMAR SINGH, Pune (IN); Shantanu Sanjay GHATNEKAR, Pune (IN); Ashutosh JOSHI, Ahmedabad (IN); Sunny Nabhiraj MASUTAGE, Miraj (IN); Xi WU, Wu Han, Hubei (CN)

(21) Appl. No.: 19/480,050

(22) PCT Filed: May 23, 2024
(86) PCT No.: PCT/US2024/030827

§ 371 Date: Oct. 30, 2025

(30) Foreign Application Priority Data
May 31, 2023 (CN) 202310637323.0

(51) Int. Cl. B01D 24/10

(52) U.S. Cl. CPC B01D 24/10; B01D 2201/301; B01D 2201/303

(57) ABSTRACT

A filtration system includes a shell and a filter element. The shell includes an inlet port and an outlet port. The filter element is disposed within the shell. The filter element includes a first endplate at least partially defining a first chamber, a second endplate at least partially defining a second chamber, a center tube coupled to the first endplate and the second endplate, an outer tube disposed outside the center tube and coupled to the first endplate and the second endplate, and at least one resin bed disposed between the outer tube and the center tube. The center tube is in fluid receiving communication with the first chamber and fluid providing communication with the second chamber. The outer tube includes one or more openings. The at least one resin bed in fluid receiving communication with one or both of the first chamber and the second chamber.

### CROSS-REFERENCE TO RELATED APPLICATIONS

This application claims the benefit of and priority to Chinese Patent Application No. 202310637323.0, filed on May 31, 2023, the entire disclosure of which is hereby incorporated by reference herein.

### FIELD

The present disclosure relates generally to filtration systems for use in filtering fluids such as coolant.

### BACKGROUND

In a fuel cell system or similar system, ions from various sources build up within a coolant fluid. When the ions build up in the coolant fluid, the ions change (e.g., increase the conductivity of the fluid), which may be detrimental for an electrically charged fuel cell system or similar system. For example, high fluid conductivity may degrade the performance of the fuel cell system and, if left unchecked, may cause the fuel cell system to fail by short circuit. Ion exchange resins-based deionizing (“DI”) filters are used to remove ions from the coolant fluid. More specifically, DI filters are used to regulate the conductivity of the coolant fluid by chemically neutralizing free ions.

### SUMMARY OF THE INVENTION

Various embodiments provide for a filtration system. The filtration system includes a shell having an inlet port and an outlet port and a filter element disposed within the shell. The filter element includes a first endplate at least partially defining a first chamber; a second endplate at least partially defining a second chamber; a center tube coupled to the first endplate and the second endplate, the center tube in fluid receiving communication with the first chamber and fluid providing communication with the second chamber; an outer tube disposed outside the center tube and coupled to the first endplate and the second endplate, the outer tube comprising one or more openings; and at least one resin bed disposed between the outer tube and the center tube, the at least one resin bed in fluid receiving communication with one or both of the first chamber and the second chamber.

In one embodiment, the first endplate defines one or more first outer openings; and the second endplate defines one or more second outer openings.

In one embodiment, a ratio of an outlet area of the one or more openings to an inlet area of the one or more first outer openings and the one or more second outer openings is between 0.25 and 0.75, inclusive.

In one embodiment, the filtration system further comprises a screen positioned over the one or more first outer openings.

In one embodiment, a ratio of a first distance between the first endplate and the one or more openings to a second distance between the first endplate and the second endplate is between 0.30 and 0.70.

In one embodiment, the filtration system further comprises a baffle that extends from the center tube towards the outer tube, the baffle at least partially dividing a chamber defined between the first endplate and the second endplate into a first chamber portion defined between the first endplate and the baffle and a second chamber portion defined between the second endplate and the baffle.

In one embodiment, the filtration system further comprises a baffle that extends from the center tube towards the outer tube, the baffle extending between the center tube and the outer tube such that the baffle divides a chamber defined between the first endplate and the second endplate into a first chamber portion defined between the first endplate and the baffle and a second chamber portion.

In one embodiment, the outer tube comprises: a first outer wall; a second outer wall, the first outer wall spaced from the second outer wall such that a gap is defined between the first outer wall and the second outer wall; and one or more ribs extending across the gap between the first outer wall and the second outer wall such that the one or more ribs define the one or more openings.

In one embodiment, the filtration system further comprises a regulating insert disposed within the inlet port, the regulating insert defining an opening enabling fluid communication into the filtration system via the inlet port.

Various other embodiments provide for a filter element. The filter element includes a first endplate at least partially defining a first chamber; a second endplate at least partially defining a second chamber; a center tube coupled to the first endplate and the second endplate, the center tube in fluid receiving communication with the first chamber and fluid providing communication with the second chamber; an outer tube disposed outside the center tube and coupled to the first endplate and the second endplate, the outer tube comprising one or more openings; and at least one resin bed disposed between the outer tube and the center tube, the at least one resin bed in fluid receiving communication with one or both of the first chamber and the second chamber.

In one embodiment, the first endplate defines one or more first outer openings; and the second endplate defines one or more second outer openings.

In one embodiment, wherein a ratio of an outlet area of the one or more openings to an inlet area of the one or more first outer openings and the one or more second outer openings is between 0.25 and 0.75, inclusive.

In one embodiment, the filter element further comprises a screen positioned over the one or more first outer openings.

In one embodiment, a ratio of a first distance between the first endplate and the one or more openings to a second distance between the first endplate and the second endplate is between 0.30 and 0.70.

In one embodiment, the filter element further comprises a baffle that extends from the center tube towards the outer tube, the baffle at least partially dividing a chamber defined between the first endplate and the second endplate into a first chamber portion defined between the first endplate and the baffle and a second chamber portion defined between the second endplate and the baffle.

In one embodiment, the filter element further comprises a baffle that extends from the center tube towards the outer tube, the baffle extending between the center tube and the outer tube such that the baffle divides a chamber defined between the first endplate and the second endplate into a first chamber portion defined between the first endplate and the baffle and a second chamber portion.

In one embodiment, the outer tube comprises a first outer wall; a second outer wall, the first outer wall spaced from the second outer wall such that a gap is defined between the first outer wall and the second outer wall; and one or more ribs extending across the gap between the first outer wall and the second outer wall such that the one or more ribs define the one or more openings.

Various other embodiments provide for a method of filtering a fluid. The method comprises passing the fluid into a filter element, the filter element comprising a first endplate at least partially defining a first chamber, wherein the fluid is passed into the first chamber. The fluid is divided between a first flow path and a second flow path, the first flow path defined by first outer openings of the first endplate, the second flow path defined by a center opening of the first endplate, a center tube of the filter element, and second outer openings of a second endplate of the filter element, wherein the center tube is coupled to the first endplate and the second endplate. The fluid is passed through at least one resin bed, the at least one resin bed in fluid receiving communication with one or both of the first outer openings of the first endplate and the second outer openings of the second endplate.

In one embodiment, the method further comprises passing the fluid through one or more openings of an outer tube of the filter element, wherein the outer tube is coupled to the first endplate and the second endplate.

In one embodiment, the fluid flowing along the first flow path is passed through the at least one resin bed in a first direction; and the fluid flowing along the second flow path is passed through the at least one resin bed in a second direction, opposite the first direction.

These and other features, together with the organization and manner of operation thereof, will become apparent from the following detailed description when taken in conjunction with the accompanying drawings, wherein like elements have like numerals throughout the several drawings described below.

### DESCRIPTION OF THE DRAWINGS

FIG. 1 is a side view of a filtration system, according to an example embodiment.

FIG. 2 is a side sectional view of the filtration system of FIG. 1.

FIG. 3 is a side sectional view of the filtration system of FIG. 1, according to another embodiment.

FIG. 4 is a side sectional view of a filtration system, according to another example embodiment.

FIG. 5 is a side sectional view of a filter element usable in the filtration system of FIG. 4.

FIG. 6 is a side sectional view of a filtration system, according to another example embodiment.

FIG. 7 is a side sectional view of a filter element usable in the filtration system of FIG. 6.

FIG. 8 is a perspective view of a filtration system, according to yet another example embodiment.

FIG. 9 is a side view of the filtration system of FIG. 8.

FIG. 10 is a side sectional view of the filtration system of FIG. 8.

FIG. 11 is a side view of a filtration system, according to another example embodiment.

FIG. 12 is a side sectional view of the filtration system of FIG. 11.

FIG. 13 is a perspective view of a filter element usable in the filtration systems shown in FIGS. 1, 3, 4, 6, 8, and/or 11, according to various example embodiments.

FIG. 14 is a perspective view of the filter element of FIG. 13, according to an example embodiment.

FIG. 15 is a sectional view of the filter element of FIG. 14.

FIG. 16 is a perspective view of a filter element usable in the filtration systems shown in FIGS. 1, 3, 4, 6, 8, and/or 11, according to another example embodiment.

FIG. 17 is a sectional view of the filter element of FIG. 16.

FIG. 18 is a perspective view of the filter element usable in the filtration systems shown in FIGS. 1, 3, 4, 6, 8, and/or 11, according to yet another example embodiment.

FIG. 19 is a sectional view of the filter element of FIG. 18.

FIG. 20 is a sectional view of a filter housing usable with a filter elements of FIGS. 1, 3, 4, 6, 8, 12, 13, 14, 16, and/or 18.

FIG. 21 is a top view of a pressure control device usable in the filter housing of FIG. 20.

FIG. 22 is a side view of the pressure control device of FIG. 21.

### DETAILED DESCRIPTION

Referring to the Figures generally, various embodiments disclosed herein relate to a filtration system. More specifically, the various embodiments disclosed herein relate to a fluid deionizing (DI) system. The DI filtration system includes an improved deionization filter element that maximizes ion exchange while reducing the pressure drop across the filtration system. The DI filter element includes ion exchange resins for removing organic, inorganic, metallic and nonmetallic ions from the coolant of a fuel cell system or a similar system, which requires a low conductivity solution.

The filter element design includes a bi-directional flow path for the coolant flowing through the filter element. The flow paths are arranged in such a way that the flow is divided within the filter element creating a bi-directional flow path where a first flow path is in a first axial direction and a second flow path is in a second axial direction, opposite the first axial direction. The bi-directional flow path advantageously reduces the overall pressure drop across the filter element for the same amount of resin compared to a conventional axial flow cylindrical DI filter. The filtration system includes a collection of resin beads (e.g., ion-exchange resin, ion-exchange polymer, etc.) that are configured to filter (e.g., deionize) the fluid passing through the filtration system. This collection of resin beads is commonly referred to as a “resin bed.” The axial flow ensures that resin utilization is uniform by compressing the resin such that tunneling formation and resin bypass are minimized. As used herein, “tunneling formation” refers to the formation of “tunnels” or passages in the resin bed. “Bypass” refers to when a fluid bypasses at least a portion of a resin bed, reducing the utilization of the resin bed and reducing the deionization of the fluid.

Various embodiments disclosed herein provide an improved DI filter system for deionizing a fluid, such as coolant. Neutralizing ions within a fluid may improve the life of the fluid and downstream devices, such as a fuel cell. More specifically, various embodiments described herein relate to an improved resin-based DI filtration system that may advantageously (i) reduce the pressure change of the fluid passing through the DI filter and/or (ii) increase utilization of the resin. The bi-directional flow path may advantageously causes the fluid to compress the resin beds towards each other. The compression of the resin beds reduces the pressure change of the fluid passing through the DI filter. Furthermore, the bi-directional flow path and resulting compression of the resin beds may advantageously reduce tunneling formation and/or bypass to increase the utilization of the resin capacity. Increasing utilization of the resin capacity before discarding or regenerating the resins may reduce operating costs of the DI filtration system. Furthermore, the increasing utilization of the resin capacity may result in greater ion neutralization. Thus, various embodiments disclosed herein may provide an improved filter system that increases or maximizes the capacity and utilization of ion exchange resins with the added benefit of low pressure drop compared to various conventional ion filter systems.

The embodiments shown and described in further detail herein relate to an inside-out flow design for a filtration system. It should be understood that the embodiments described herein may be utilized in other filtration system arrangements. For example, the embodiments described herein may be utilized in an outside-in flow design and/or other types of filtration systems. Additionally, the filtration system may include more or fewer components than as shown in the Figures. Accordingly, references to various components being within, downstream, exterior, upstream, and the like are relative to the embodiments shown in Figures, and it should be understood that other embodiments, such as an outside-in flow design for a filtration system, may have the same or similar components provided in a different arrangement.

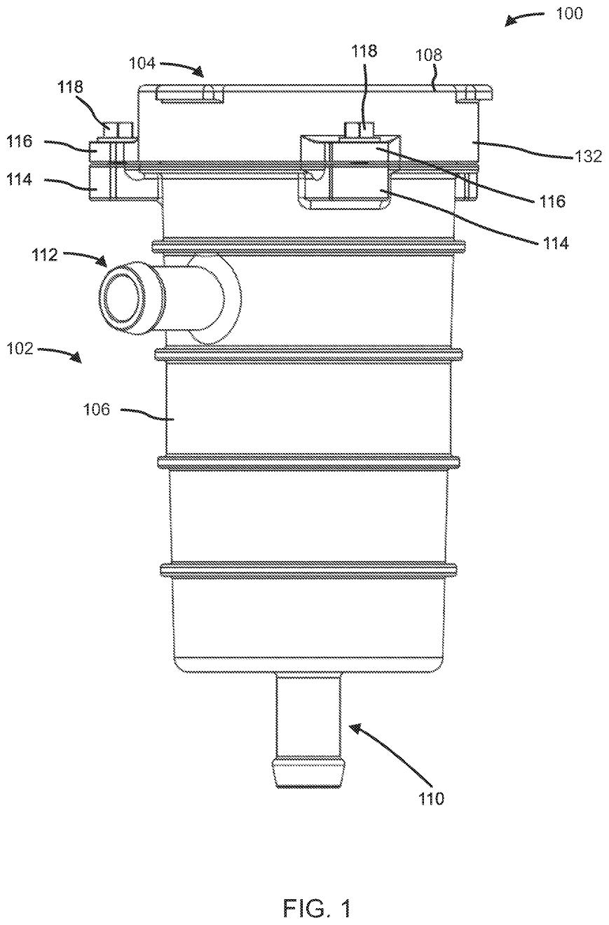

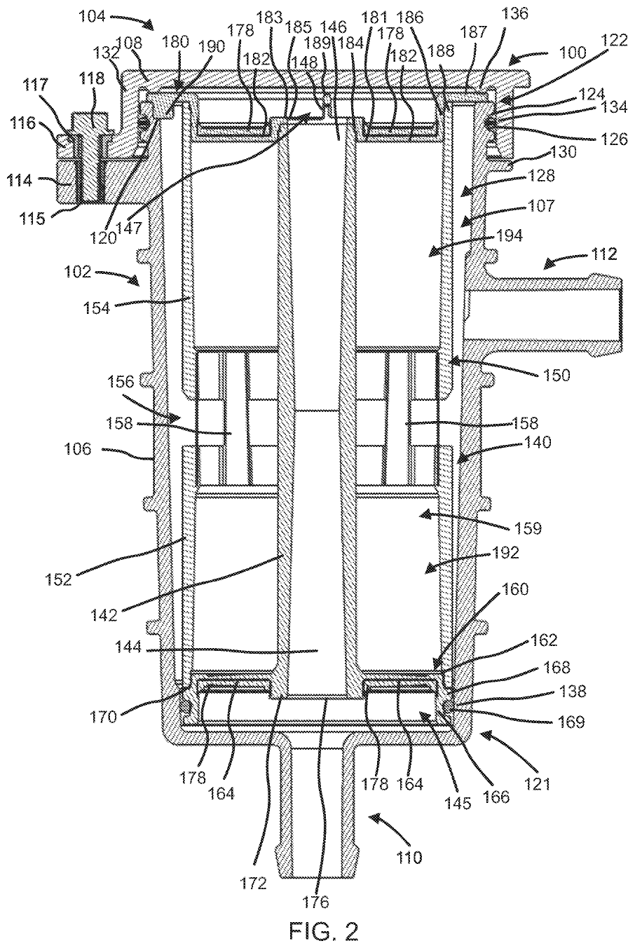

Now referring to FIGS. 1 and 2, various views of a filtration system 100 are shown, according to an example embodiment. The filtration system 100 is configured to receive an ionized fluid (e.g., coolant, etc.), filter the fluid by a deionizing process, and provide the deionized fluid to a downstream device, such as a fuel cell stack. As shown, the filtration system 100 includes a shell 102, a cover 104, and a filter element 140. In some embodiments, the shell 102 and the filter element 140 cooperate to define a filter cartridge. In other embodiments, the cover 104 and the filter element 140 cooperate to define the filter cartridge. It should be understood that the filtration system 100 may include more or fewer components than as shown in FIG. 1.

The shell 102 includes a shell wall 106. The shell wall 106 at least partially defines an internal volume 107. The shell 102 is configured to receive at least a portion of the filter element 140 therein such that the filter element 140 is at least partially contained within the internal volume 107. The shell 102 also includes a first port 110 and a second port 112. The first port 110 is disposed proximate a first end 121 of the filtration system 100. The second port 112 is disposed between the first end 121 of the filtration system 100 and a second end 122 of the filtration system 100, opposite the first end 121. In the embodiment shown in FIGS. 1 and 2, the first port 110 is configured as an inlet port. The first port 110 is in fluid receiving communication with an upstream device, such as a pump, a fluid reservoir, etc. The first port 110 is in fluid providing communication with the filter element 140. As shown, the first port 110 extends in an axial direction. The second port 112 is configured as an outlet port. The second port 112 is in fluid receiving communication with the filter element 140. The second port 112 is in fluid providing communication with a downstream device, such as a pump, a fluid reservoir, etc. As shown, the second port 112 extends in a radial direction.

The shell 102 also includes one or more shell mounting flanges 114. In the embodiment shown in FIGS. 1 and 2, the shell 102 includes four shell mounting flanges 114 (two shown and two hidden from view). However, it should be understood that the shell 102 may include more or fewer shell mounting flanges 114. Each of the one or more shell mounting flanges 114 extend radially away from the shell wall 106. Each of the one or more shell mounting flanges 114 defines a flange opening 115. The flange opening 115 is configured to receive a fastener 118.

The shell 102 also includes a notch 120 that is formed in the shell wall 106. The notch 120 is disposed proximate the second end 122 of the filtration system 100. The notch 120 is configured to receive a portion of the filter element 140, as described in greater detail below.

The shell 102 also includes a shell sealing channel 124. The shell sealing channel 124 is disposed proximate the second end 122 of the filtration system 100 and on an outer surface of the shell wall 106. The shell sealing channel 124 is configured to receive a first sealing member 126 (e.g., O-ring, gasket, etc.).

The shell 102 also includes a shell radial flange 130. The shell radial flange 130 extends radially away from the shell wall 106. The shell radial flange 130 extends between each of the one or more mounting flanges 114. The shell radial flange 130 is configured to limit the movement of the cover 104 relative to the shell 102 as described in greater detail below.

The cover 104 includes a cover end wall 108. The cover 104 also includes a cover side wall 132 that extends axially away from the cover end wall 108 and toward the shell 102. The cover 104 also includes one or more cover mounting flanges 116. In the embodiment shown in FIGS. 1 and 2, the cover 104 includes four cover mounting flanges 116 (two shown and two hidden from view). However, it should be understood that the cover 104 may include more or fewer cover mounting flanges 116. Each of the one or more cover mounting flanges 116 extends radially away from the cover side wall 132. Each of the one or more cover mounting flanges 116 defines a flange opening 117. Each of the flange openings 117 is configured to align with a corresponding flange opening 115 of the one or more shell mounting flanges 114. The flange opening 117 is configured to receive the fastener 118, such that the fastener is received by the flange opening 117 and the flange opening 115, thereby coupling the cover 104 to the shell 102. When the cover 104 is coupled to the shell 102, the cover 104 and the shell 102 cooperate to define the internal volume 107.

The cover side wall 132 defines a cover sealing surface 134. The first sealing member 126 is configured to engage the shell sealing channel 124 and the cover sealing surface 134 and form a seal therebetween. When the cover 104 is coupled to the shell 102, the cover side wall 132 may contact the shell radial flange 130 such that the shell radial flange 130 limits the movement of the cover 104 relative to the shell 102.

The cover 104 also includes an annular flange 136. The annular flange 136 extends axially away from the cover end wall 108 and towards the filter element 140. The annular flange 136 is configured to contact a portion of the filter element 140, as described in greater detail below.

The filter element 140 is disposed within the internal volume 107 defined by the cover 104 and the shell 102. The filter element 140 includes a center tube 142, an outer tube 150, a first endplate 160, and a second endplate 180. When the filter element 140 is disposed within the internal volume 107, an outer chamber 128 is defined between the filter element 140 and the shell wall 106. The outer chamber 128 is in fluid receiving communication with the filter element 140. The outer chamber 128 is in fluid providing communication with the second port 112.

The center tube 142 is a substantially hollow tube that allows a fluid to flow therethrough. The center tube 142 has a first end 144 proximate the first end 121 of the filtration system 100. In the embodiment shown in FIGS. 1 and 2, the first end 144 of the center tube 142 is in fluid receiving communication with a first chamber 145. The first chamber 145 is defined between the first endplate 160 and the shell wall 106. The first chamber 145 is in fluid receiving communication with the first port 110. The center tube 142 has a second end 146 proximate the second end 122 of the filtration system 100, opposite the first end 144. The second end 146 of the center tube 142 is in fluid providing communication with a second chamber 147. The second chamber 147 is defined between the second endplate 180 and the cover 104. The second chamber 147 is in fluid receiving communication with the center tube 142.

The center tube 142 also includes an axial flange 148. The axial flange 148 extends towards the cover 104 (e.g., in an axial direction) and contacts a portion of the second endplate 180, as described in greater detail below.

The outer tube 150 is a substantially hollow tube. The outer tube 150 is disposed around an outside of the center tube 142 such that a chamber 159 defined between the center tube 142 and the outer tube 150. More specifically, the chamber 159 is defined between the center tube 142, the outer tube 150, the first endplate 160, and the second endplate 180. The outer tube 150 includes a first outer wall 152 and a second outer wall 154. A gap is defined between the first outer wall 152 and the second outer wall 154. The outer tube 150 includes one or more ribs 158 that extend across the gap between the first outer wall 152 and the second outer wall 154 such that the ribs 158 define one or more openings 156. In some embodiments, a mesh screen (not shown) is positioned over the one or more openings 156. In some embodiments, the mesh screen is co-molded with the outer tube 150. In other embodiments, the filter element 140 does not include a mesh screen positioned over the one or more openings 156. The one or more openings 156 are in fluid providing communication with the outer chamber 128.

In some embodiments, the first outer wall 152, the second outer wall 154, and the one or more ribs 158 are formed as a single monolithic part. In other embodiments, the first outer wall 152, the second outer wall 154, and the one or more ribs 158 are separate pieces, and the first outer wall 152 is coupled to the one or more ribs 158 and the second outer wall 154 is coupled to the one or more ribs (e.g., by an ultrasonic welding process or other suitable process).

The first endplate 160 is disposed proximate the first end 121 of the filtration system 100. The first endplate 160 includes a first endplate end wall 162. The first endplate end wall 162 defines one or more first endplate outer openings 164 that enable fluid communication between the first chamber 145 and the outer tube 150, or, more specifically, chamber 159. The first endplate 160 also includes a first endplate side wall 166. The first endplate side wall 166 extends axially away from the first endplate end wall 162 and away from the second endplate 180. The first endplate side wall 166 extends around a periphery of the first endplate end wall 162. The first endplate 160 also includes a first endplate sealing channel 168 that is disposed on an outer surface of the first endplate side wall 166. The first endplate sealing channel 168 is configured to receive a first endplate sealing member 169 therein.

The first endplate 160 also includes a first outer mounting portion 170 that is defined by the first endplate end wall 162 and the first endplate side wall 166. The first outer mounting portion 170 is configured to receive a portion of the first outer wall 152 such that the first outer wall 152 is coupled to the first endplate 160.

The first endplate 160 also includes a first endplate center wall 172. The first endplate center wall 172 is disposed within an inner edge of the first endplate end wall 162. The first endplate center wall 172 extends axially away from the first endplate end wall 162 and away from the second endplate 180. The first endplate center wall 172 defines a first endplate center opening 176. The first endplate 160 is coupled to the center tube 142 such that the opening 176 enables fluid communication between the first chamber 145 and the center tube 142.

In some embodiments, a screen 178 is positioned over the one or more first endplate outer openings 164. In some embodiments, the screen 178 is co-molded with the first endplate 160. In other embodiments, the first endplate 160 does not include a screen positioned over the one or more first endplate outer openings 164.

The second endplate 180 is disposed proximate the second end 122 of the filtration system 100. The second endplate 180 includes a second endplate end wall 181. The second endplate end wall 181 defines one or more second endplate outer openings 182 that enable fluid communication between the second chamber 147 and the outer tube 150, or, more specifically, the fluid path defined between the inner tube 142 and the outer tube 150 (e.g., the chamber 159).

The second endplate 180 also includes a second endplate center wall 183. The second endplate center wall 183 is disposed within an inner edge of the second endplate end wall 181. The second endplate center wall 183 extends axially away from the second endplate end wall 181 and away from the first endplate 160. In some embodiments, the second endplate center wall 183 includes a second inner mounting portion 184. The second inner mounting portion 184 is configured to receive a portion of the center tube 142 such that the center tube 142 is coupled to the second endplate 180. The second endplate center wall 183 defines a second endplate center opening 185 that is configured to enable fluid communication between the second chamber 147 and the center tube 142.

The second endplate 180 also includes a second endplate side wall 186. The second endplate side wall 186 extends axially away from the second endplate end wall 181 and away from the first endplate 160. The second endplate side wall 186 extends around a periphery of the second endplate end wall 181. The second endplate 180 also includes a second endplate flange 187 that extends radially away from the second endplate side wall 186. The second endplate flange 187 extends between the cover 108 and the shell 102. More specifically, the second endplate flange 187 extends between the annular flange 136 and the shell wall 106 such that the second endplate flange 187 contacts the annular flange 136 and the shell wall 106.

The second endplate 180 also includes a second outer mounting portion 188. The second endplate side wall 186 and the second endplate flange 187 cooperate to define the second outer mounting portion 188. The second outer mounting portion 188 is configured to receive a portion of the second outer wall 154 such that the second outer wall 154 is coupled to the second endplate 180.

The second endplate 180 also includes a rib 189 that extends radially away from the second endplate center wall 183 and axially away from the second endplate center opening 185, away from the first endplate 160. The rib 189 contacts the axial flange 148 of the center tube 142 such that the center tube 142 is prevented from moving relative to the filter element 140.

The second endplate 180 also includes a projection 190. The projection 190 extends axially away from the second endplate flange 187 towards the first endplate 160 and towards the shell wall 106. More specifically, the projection 190 is received by the notch 120. When the projection 190 is received by the notch 120, the projection 190 contacts the shell wall 106 at the notch 120 such that the filter element 140 is prevented from rotating relative to the shell 102.

In some embodiments, a screen 178 is positioned over the one or more second endplate outer openings 182. In some embodiments, the screen 178 is co-molded with the second endplate 180. In other embodiments, the second endplate 180 does not include a screen positioned over the one or more second endplate outer openings 182.

The element 140 also includes a first resin bed 192. The first resin bed 192 is formed on the first outer wall 152 between an inner surface of the first outer wall 152 and an outer surface of the center tube 142. The first resin bed 192 extends between the first endplate 160 and the one or more openings 156. The first resin bed 192 is configured to filter the fluid passing through the outer tube 150. More specifically, the first resin bed 192 is configured to deionize the fluid flowing from the first endplate 160, through the outer tube 150, and flowing out of the one or more openings 156.

The filter element 140 also includes a second resin bed 194. The second resin bed 194 is formed on the second outer wall 154 between an inner surface of the second outer wall 154 and an outer surface of the center tube 142. The second resin bed 194 extends between the second endplate 180 and the one or more openings 156. The second resin bed 194 is configured to filter the fluid passing through the outer tube 150. More specifically, the second resin bed 194 is configured to deionize the fluid flowing from the second endplate 180, through the outer tube 150, and flowing out of the one or more openings 156.

The one or more first endplate outer openings 164 are structured to direct a fluid in a first direction from the first chamber 145 towards the first resin bed 192. The one or more second endplate outer openings 182 are structured to direct the fluid in a second direction, opposite the first direction, from the second chamber 147 towards the second resin bed 194.

In some embodiments, the first resin bed 192 and the second resin bed 194 are formed as a single, unitary, resin bed, such that the filter element 140 includes a single, contiguous, resin bed. In these embodiments, the “first resin bed” 192 refers to a first portion of the resin bed that is defined between the first endplate 160 and the one or more openings 156, and the “second resin bed” 194 refers to a second portion of the resin bed that is defined between the second endplate 180 and the one or more openings 156.

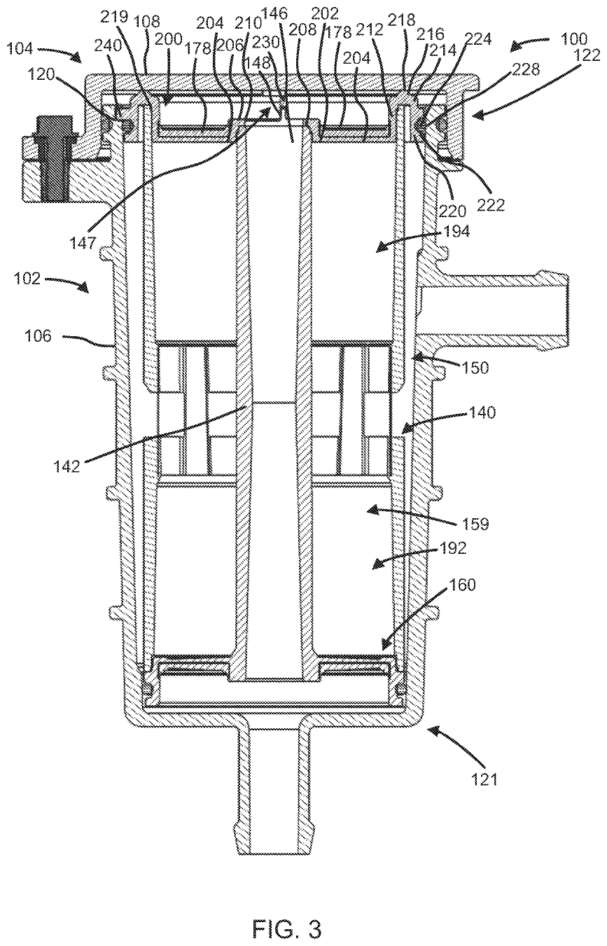

Now referring to FIG. 3, a side sectional view of the filtration system 100 of FIG. 1 is shown, according to another embodiment. The filtration system 100 shown in FIG. 3 is substantially similar to the filtration system 100 shown in FIGS. 1 and 2. For example, the filtration system 100 shown in FIG. 3 includes a shell 102, a cover 104, and a filter element 140.

In contrast with the cover 104 shown in FIGS. 1 and 2, the cover 104 shown in FIG. 3 does not include the annular flange 136. Furthermore, the filter element 140 shown FIG. 3 is substantially similar to the filter element 140 shown in FIG. 2, except that the filter element 140 shown FIG. 3 includes a different second endplate 200.

The second endplate 200 of FIG. 3 is disposed proximate the second end 122 of the filtration system 100. The second endplate 200 includes a second endplate end wall 202. The second endplate end wall 202 defines one or more second endplate outer openings 204 that enable fluid communication between the second chamber 147 and the outer tube 150, or, more specifically, the fluid path defined between the inner tube 142 and the outer tube 150 (e.g., the chamber 159).

The second endplate 200 also includes a second endplate center wall 206. The second endplate center wall 206 is disposed within an inner edge of the second endplate end wall 202. The second endplate center wall 206 extends axially away from the second endplate end wall 202 and away from the first endplate 160. In some embodiments, the second endplate center wall 206 includes a second inner mounting portion 208. The second inner mounting portion 208 is configured to receive a portion of the center tube 142 such that the center tube 142 is coupled to the second endplate 200. The second endplate center wall 208 defines a second endplate center opening 210 that is configured to enable fluid communication between the second chamber 147 and the center tube 142.

The second endplate 200 also includes a second endplate side wall 212. The second endplate side wall 212 extends axially away from the second endplate end wall 202 and away from the first endplate 160. The second endplate side wall 212 extends around a periphery of the second endplate end wall 202.

The second endplate 200 also includes a second endplate flange 214 that extends radially away from the second endplate side wall 212. The second endplate 200 also includes an annular projection 216 that extends axially away from the second endplate flange 214 and towards the cover end wall 108. The annular projection 216 contacts the cover end wall 108 at a cover contact surface 218 such that the filter element 140 is prevented from moving in an axial direction towards the cover 104.

The second endplate 180 also includes a second outer mounting portion 219. The second endplate side wall 212 and the second endplate flange 214 cooperate to define the second outer mounting portion 219. The second outer mounting portion 219 is configured to receive a portion of the second outer wall 154 such that the second outer wall 154 is coupled to the second endplate 200.

The second endplate 200 also includes a second endplate skirt 220. The second endplate skirt 220 extends axially away from the second endplate flange 214 and towards the first endplate 160. The second endplate 200 includes a second endplate sealing channel 222 that is disposed on an outer surface of the second endplate skirt 220. The second endplate sealing channel 222 is configured to receive a second endplate sealing member 224.

In some embodiments, a screen 178 is positioned over the one or more second endplate outer openings 204. In some embodiments, the screen 178 is co-molded with the second endplate 200. In other embodiments, the second endplate 200 does not include a screen positioned over the one or more second endplate outer openings 204.

The second endplate 200 also includes a rib 230 that extends radially away from the second endplate center wall 206 and axially away from the second endplate center opening 210 towards the cover end wall 108. The rib 230 contacts the axial flange 148 of the center tube 142 such that the center tube 142 is prevented from moving relative to the filter element 140.

The second endplate 200 also includes a projection 240. The projection 240 extends radially away from the second endplate skirt 220 and towards the shell wall 106. More specifically, the projection 240 is received by the notch 120. When the projection 240 is received by the notch 120, the projection 240 contacts the shell wall 106 at the notch 120 such that the filter element 140 is prevented from rotating relative to the shell 102.

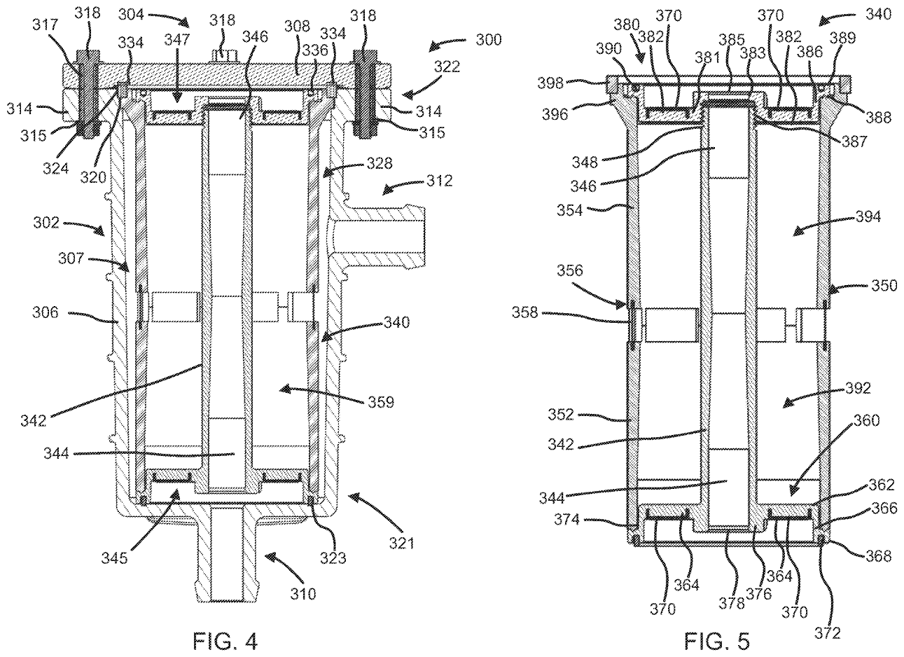

Now referring to FIGS. 4 and 5, a side-sectional view of a filtration system 300 and a side-sectional view of a filter element 340 usable in the filtration system 300 are shown, according to an example embodiment. The filtration system 300 is configured to receive an ionized fluid (e.g., coolant, etc.), filter the fluid by a deionizing process, and provide the deionized fluid to a downstream device, such as a fuel cell stack. As shown, the filtration system 300 includes a shell 302, a cover 304, and a filter element 340. In some embodiments, the shell 302 and the filter element 340 cooperate to define a filter cartridge. In other embodiments, the cover 304 and the filter element 340 cooperate to define the filter cartridge. It should be understood that the filtration system 300 may include more or fewer components than as shown in FIGS. 4 and 5.

The shell 302 includes a shell wall 306. The shell wall 306 at least partially defines an internal volume 307. The shell 306 is configured to receive at least a portion of the filter element 340 therein such that the filter element 340 is at least partially contained within the internal volume 307.

The shell 302 also includes a first port 310 and a second port 312. The first port 310 is disposed proximate a first end 321 of the filtration system 300. The second port 312 is disposed between the first end 321 of the filtration system 300 and a second end 322 of the filtration system 300, opposite the first end 321. In the embodiment shown in FIGS. 4 and 5, the first port 310 is configured as an inlet port. The first port 310 is in fluid receiving communication with an upstream device, such as a pump, a fluid reservoir, etc. The first port 310 is in fluid providing communication with the filter element 340. As shown the first port 310 extends in an axial direction. The second port 312 is configured as an outlet port. The second port 312 is in fluid receiving communication with the filter element 340. The second port 312 is in fluid providing communication with a downstream device, such as a pump, a fluid reservoir, etc. As shown, the second port 312 extends in a radial direction.

The shell 302 also includes a shell mounting flange 314. The shell mounting flange 314 is disposed around an outer surface of the shell wall 306 at the second end 322 of the filtration system 300. In some embodiments, the shell mounting flange 314 extends contiguously around the shell wall 306. In other embodiments, the shell mounting flange 314 is dis-contiguous such that shell mounting flange 314 includes one or more segments disposed around the shell wall 306. The shell mounting flange 314 extends radially away from the shell wall 106. The shell mounting flange 314 defines one or more flange openings 315. The flange opening 315 is configured to receive a fastener 318.

The shell 302 also includes a notch 320 that is formed in the shell wall 306. The notch 320 is disposed proximate the second end 322 of the filtration system 300. The notch 320 is configured to receive a portion of the filter element 340, as described in greater detail below.

The shell 302 includes a first shell sealing surface 323. The first shell sealing surface 323 is disposed at or proximate the first end 321 of the filtration system 300 and on an inner surface of the shell wall 306. As described below, the first shell sealing surface 323 is configured to engage a first sealing member 372 (e.g., O-ring, gasket, etc.).

The shell 302 also includes a second shell sealing surface 324. The second shell sealing surface 324 is disposed proximate the second end 322 of the filtration system 300 and on an outer surface of the shell wall 306. More specifically, the second shell sealing surface 324 is disposed at the notch 320. The second shell sealing surface 324 is configured to engage a second sealing member 398 (e.g., O-ring, gasket, etc.).

The cover 304 includes a cover end wall 308. The cover end wall 308 defines one or more cover opening 317. Each of the cover openings 317 is configured to align with a corresponding flange opening 315 of the shell mounting flange 314. The cover opening 317 is configured to receive the fastener 318, such that the fastener 318 is received by the cover opening 317 and the flange opening 315, thereby coupling the cover 304 to the shell 302. When the cover 304 is coupled to the shell 302, the cover 304 and the shell 302 cooperate to define the internal volume 307.

The cover end wall 308 defines a first cover sealing surface 334. The second sealing member 398 is configured to engage the second shell sealing surface 324 and the first cover sealing surface 334 and form a seal therebetween.

The cover end wall 308 defines a second cover sealing surface 336. A third sealing member 390 (e.g., O-ring, gasket, etc.) is configured to engage the second cover sealing surface 336 and a portion of the filter element 340 and form a seal therebetween.

The filter element 340 is disposed within the internal volume 307 defined by the cover 304 and the shell 302. The filter element 340 includes a center tube 342, an outer tube 350, a first endplate 360, and a second endplate 380. When the filter element 340 is disposed within the internal volume 307, an outer chamber 328 is defined between the filter element 340 and the shell wall 306. The outer chamber 328 is in fluid receiving communication with the filter element 340. The outer chamber 328 is in fluid providing communication with the second port 312.

The center tube 342 is a substantially hollow tube that allows a fluid to flow therethrough. The center tube 342 has a first end 344 proximate the first end 321 of the filtration system 300. The first end 344 of the center tube 342 is in fluid receiving communication with a first chamber 345. The first chamber 345 is defined between the first endplate 360 and the shell wall 306. The first chamber 345 is in fluid receiving communication with the first port 310. The center tube 342 has a second end 346 proximate the second end 322 of the filtration system 300, opposite the first end 344. The second end 346 of the center tube 342 is in fluid providing communication with a second chamber 347. The second chamber 347 is defined between the second endplate 380 and the cover 304. The second chamber 347 is in fluid receiving communication with the center tube 342.

The center tube 342 also includes one or more threads 348. The one or more threads 348 are disposed on an outer surface of the center tube 342 at the second end 346. The one or more threads 348 is configured to enable coupling the center tube 342 to the second endplate 380, as described in greater detail below.

The outer tube 350 is a substantially hollow tube. The outer tube 350 is disposed around an outside of the center tube 342 such that a chamber 359 defined between the center tube 342 and the outer tube 350. More specifically, the chamber 359 is defined between the center tube 342, the outer tube 350, the first endplate 360, and the second endplate 380. The outer tube 350 includes a first outer wall 352 and a second outer wall 354. A gap is defined between the first outer wall 352 and the second outer wall 354. The outer tube 350 includes one or more ribs 358 that extend across the gap between the first outer wall 352 and the second outer wall 354 such that the ribs 358 define one or more openings 356. In some embodiments a mesh screen (not shown) is positioned over the one or more openings 356. In some embodiments, the mesh screen is co-molded with the outer tube 350. In other embodiments, the filter element 340 does not include a mesh screen positioned over the one or more openings 356. The one or more openings 356 are in fluid providing communication with the outer chamber 328.

In some embodiments, the first outer wall 352, the second outer wall 354, and the one or more ribs 358 are formed as a single monolithic part. In other embodiments, the first outer wall 352, the second outer wall 354, and the one or more ribs 358 are separate pieces, and the first outer wall 352 is coupled to the one or more ribs 358 and the second outer wall 354 is coupled to the one or more ribs (e.g., by an ultrasonic welding process or other suitable process).

The outer tube 350 also includes a flange 396 that extends axially and radially away from the second outer wall 354 and towards the first cover sealing surface 334. The flange 396 is configured to engage the second sealing member 398 such that the second sealing member 398 forms a seal between the second shell sealing surface 324, the first cover sealing surface 334 and the filter element 340 (e.g., at the flange 396).

The first endplate 360 is disposed proximate the first end 321 of the filtration system 300. The first endplate 360 includes a first endplate end wall 362. The first endplate end wall 362 defines one or more first endplate outer openings 364 that enable fluid communication between the first chamber 345 and the outer tube 350, or, more specifically, the chamber 359.

In some embodiments, a screen 370 is positioned over the one or more first endplate outer openings 364. In some embodiments, the screen 370 is co-molded with the first endplate 360. In other embodiments, the first endplate 360 does not include a screen positioned over the one or more first endplate outer openings 364.

The first endplate 360 also includes a first endplate side wall 366. The first endplate side wall 366 extends axially away from the first endplate end wall 362 and away from the second endplate 380. The first endplate side wall 366 extends around a periphery of the first endplate end wall 362.

The first endplate 360 also includes a first endplate sealing channel 368 that is disposed at an end of the first endplate side wall 366, opposite the first endplate end wall 362. The first endplate sealing channel 368 is configured to receive the first sealing member 372.

The first endplate 360 also includes a first outer mounting portion 374 that is defined by the first endplate end wall 362 and the first endplate side wall 366. The first outer mounting portion 370 is configured to receive a portion of the first outer wall 352 such that the first outer wall 352 is coupled to the first endplate 360.

The first endplate 360 also includes a first endplate center wall 376. The first endplate center wall 376 is disposed within an inner edge of the first endplate end wall 362. The first endplate center wall 376 extends axially away from the first endplate end wall 362 and away from the second endplate 380. The first endplate center wall 376 defines a first endplate center opening 378. The first endplate 360 is coupled to the center tube 342 such that the first endplate center opening 378 is configured to enable fluid communication between the first chamber 345 and the center tube 342.

The second endplate 380 is disposed proximate the second end 322 of the filtration system 300. The second endplate 380 includes a second endplate end wall 381. The second endplate end wall 381 defines one or more second endplate outer openings 382 that enable fluid communication between the second chamber 347 and the outer tube 350, or, more specifically, the fluid path defined between the inner tube 342 and the outer tube 350 (e.g., the chamber 359).

The second endplate 380 also includes a second endplate center wall 383. The second endplate center wall 383 is disposed within an inner edge of the second endplate end wall 381. The second endplate center wall 383 extends axially away from the second endplate end wall 381 and away from the first endplate 360. In some embodiments, the second endplate center wall 383 includes one or more threads 387 disposed on an inside surface of the second endplate center wall 383. The one or more threads 387 are configured to engage the one or more threads 348 thereby coupling the center tube 342 to the second endplate 380. The second endplate center wall 383 defines a second endplate center opening 385 that is configured to enable fluid communication between the second chamber 347 and the center tube 342.

The second endplate 380 also includes a second endplate side wall 386. The second endplate side wall 386 extends axially away from the second endplate end wall 381 and away from the first endplate 360. The second endplate side wall 386 extends around a periphery of the second endplate end wall 381.

The second endplate 380 also includes a second outer mounting portion 388. The second outer mounting portion 388 extends radially away from the second endplate side wall 386. The second outer mounting portion 388 is configured to receive a portion of the second outer wall 354 such that the second outer wall 354 is coupled to the second endplate 380.

The second endplate 380 also includes a second endplate sealing channel 389 that extends around the second endplate side wall 386 and axially away from the second outer mounting portion 388. The second endplate sealing channel 389 is configured to receive the third sealing member 390 such that the third sealing member 390 engages the second endplate 380 at the second endplate sealing channel 389.

In some embodiments, a screen 370 is positioned over the one or more second endplate outer openings 382. In some embodiments, the screen 370 is co-molded with the second endplate 380. In other embodiments, the second endplate 380 does not include a screen positioned over the one or more second endplate outer openings 382.

The filter element 340 also includes a first resin bed 392. The first resin bed 392 is formed on the first outer wall 352 between an inner surface of the first outer wall 352 and an outer surface of the center tube 342. The first resin bed 392 extends between the first endplate 360 and the one or more openings 356. The first resin bed 392 is configured to filter the fluid passing through the outer tube 350. More specifically, resin filter media is configured to deionize the fluid flowing from the first endplate 360, through the outer tube 350, and flowing out of the one or more openings 356.

The filter element 340 also includes a second resin bed 394. The second resin bed 394 is formed on the second outer wall 354 between an inner surface of the second outer wall 354 and an outer surface of the center tube 342. The second resin bed 394 extends between the second endplate 380 and the one or more openings 356. The second resin bed 394 is configured to filter the fluid passing through the outer tube 350. More specifically, the second resin bed 394 is configured to deionize the fluid flowing from the second endplate 380, through the outer tube 350, and flowing out of the one or more openings 356.

The one or more first endplate outer openings 364 are structured to direct a fluid in a first direction from the first chamber 345 towards the first resin bed 392. The one or more second endplate outer openings 382 are structured to direct the fluid in a second direction, opposite the first direction, from the second chamber 347 towards the second resin bed 394.

In some embodiments, the first resin bed 392 and the second resin bed 394 are formed as a single, unitary, resin bed, such that the filter element 340 includes a single, contiguous, resin bed. In these embodiments, the “first resin bed” 392 refers to a first portion of the resin bed that is defined between the first endplate 360 and the one or more openings 356, and the “second resin bed” 394 refers to a second portion of the resin bed that is defined between the second endplate 380 and the one or more openings 356.

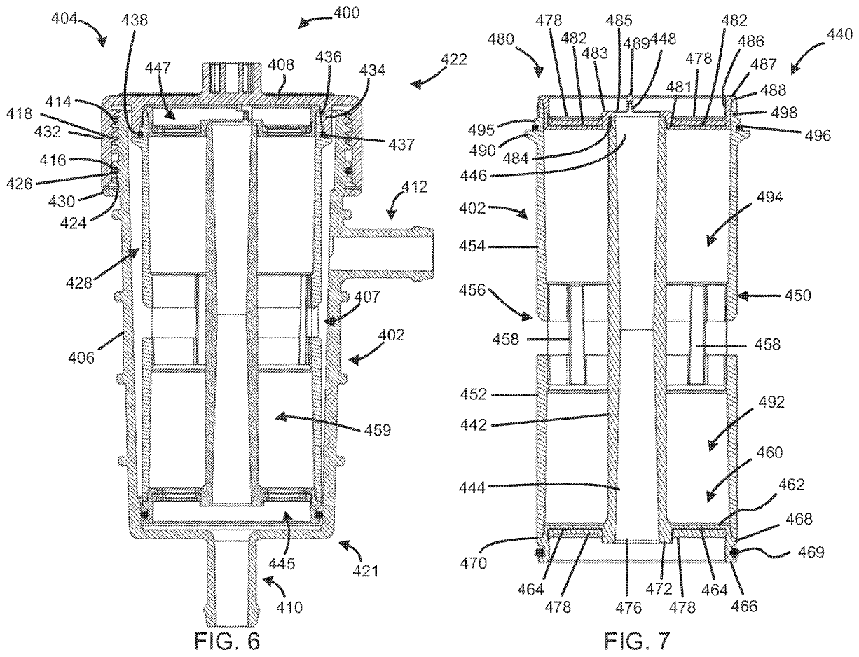

Now referring to FIGS. 6 and 7, a side-sectional view of a filtration system 400 and a side-sectional view of a filter element 440 usable in the filtration system 400 are shown, according to an example embodiment. The filtration system 400 is configured to receive an ionized fluid (e.g., coolant, etc.), filter the fluid by a deionizing process, and provide the deionized fluid to a downstream device, such as a fuel cell stack. As shown, the filtration system 400 includes a shell 402, a cover 404, and the filter element 440. In some embodiments, the shell 402 and the filter element 440 cooperate to define a filter cartridge. In other embodiments, the cover 404 and the filter element 440 cooperate to define the filter cartridge. It should be understood that the filtration system 400 may include more or fewer components than as shown in FIG. 6.

The shell 402 includes a shell wall 406. The shell wall 406 at least partially defines an internal volume 407. The shell 406 is configured to receive at least a portion of the filter element 440 therein such that the filter element 440 is at least partially contained within the internal volume 407. The shell 402 also includes a first port 410 and a second port 412. The first port 410 is disposed proximate a first end 421 of the filtration system 400. The second port 412 is disposed between the first end 421 of the filtration system 400 and a second end 422 of the filtration system 400, opposite the first end 421. In the embodiment shown in FIGS. 6 and 7, the first port 410 is configured as an inlet port. The first port 410 is in fluid receiving communication with an upstream device, such as a pump, a fluid reservoir, etc. The first port 410 is in fluid providing communication with the filter element 440. As shown, the first port 410 extends in an axial direction. The second port 412 is configured as an outlet port. The second port 412 is in fluid receiving communication with the filter element 440. The second port 412 is in fluid providing communication with a downstream device, such as a pump, a fluid reservoir, etc. As shown, the second port 412 extends in a radial direction.

The shell 402 also includes one or more shell threads 414. In the embodiment shown in FIG. 6 the shell threads 414 are external threads disposed on an outer surface of the shell wall 406. In other embodiments, the shell threads 414 may be internal threads disposed on an inside surface of the shell wall 406. The shell threads 414 are configured to engage a portion of the cover 404, as described in greater detail below.

The shell 402 also includes a shell sealing channel 424. The shell sealing channel 424 is disposed proximate the second end 422 of the filtration system 400 and on an outer surface of the shell wall 406. The shell sealing channel 424 is configured to receive a first sealing member 426 (e.g., O-ring, gasket, etc.).

The shell 402 also includes a shell radial flange 430. The shell radial flange 430 extends radially away from the shell wall 406. The shell radial flange 430 is configured to limit the movement of the cover 404 relative to the shell 402 as described in greater detail below.

The cover 404 includes a cover end wall 408. The cover 404 also includes a cover side wall 432 that extends axially away from the cover end wall 408 and towards the shell 402. The cover side wall 432 includes a side wall sealing surface 416. The first sealing member 426 is configured to engage the side wall sealing surface 416 to form a seal between the cover 404 and the shell 402.

The cover side wall 432 also includes one or more cover threads 418. In the embodiment shown in FIG. 6 the cover threads 418 are internal threads disposed on an inner surface of the cover 404. In other embodiments, the cover threads 418 may be external threads disposed on an outside surface of the cover 404. The cover threads 418 are configured to engage the shell threads 414 thereby coupling the cover 404 to the shell 402. When the cover 404 is coupled to the shell 402, the cover side wall 432 may contact the shell radial flange 430 such that the shell radial flange 430 limits the movement of the cover 404 relative to the shell 402.

The cover 404 also includes an annular flange 434. The annular flange 434 extends axially away from the cover end wall 408 and towards the filter element 440. The annular flange 434 includes one or more cover flange threads 436. In the embodiment shown in FIG. 6 the cover flange threads 436 are internal threads disposed on an inner surface of the annular flange 434. In other embodiments, the cover flange threads 436 may be external threads disposed on an outer surface of the annular flange 434. The cover flange threads 436 are configured to engage a portion of the filter element 440, as described in greater detail below.

The annular flange 434 also includes a flange sealing surface 437. A second sealing member 438 is configured to engage the flange sealing surface 437 and a portion of the filter element 440, as described below.

The filter element 440 is disposed within the internal volume 407 defined by the cover 404 and the shell 402. The filter element 440 includes a center tube 442, an outer tube 450, a first endplate 460, and a second endplate 480. When the filter element 440 is disposed within the internal volume 407, an outer chamber 428 is defined between the filter element 440 and the shell wall 406. The outer chamber 428 is in fluid receiving communication with the filter element 440. The outer chamber 428 is in fluid providing communication with the second port 412.

The center tube 442 is a substantially hollow tube that allows a fluid to flow therethrough. The center tube 442 has a first end 444 proximate the first end 421 of the filtration system 400. The first end 444 of the center tube 442 is in fluid receiving communication with a first chamber 445. The first chamber 445 is defined between the first endplate 460 and the shell wall 406. The first chamber 445 is in fluid receiving communication with the first port 410. The center tube 442 has a second end 446 proximate the second end 422 of the filtration system 400, opposite the first end 444. The second end 446 of the center tube 442 is in fluid providing communication with a second chamber 447. The second chamber 447 is defined between the second endplate 480 and the cover 404. The second chamber 447 is in fluid receiving communication with the center tube 442.

The center tube 442 also includes an axial flange 448. The axial flange 448 extends towards the cover 404 (e.g., in an axial direction) and contacts a portion of the second endplate 480, as described in greater detail below.

The outer tube 450 is a substantially hollow tube. The outer tube 450 is disposed around an outside of the center tube 442 such that a chamber 459 defined between the center tube 442 and the outer tube 450. More specifically, the chamber 459 is defined between the center tube 442, the outer tube 450, the first endplate 460, and the second endplate 480. The outer tube 450 includes a first outer wall 452 and a second outer wall 454. A gap is defined between the first outer wall 452 and the second outer wall 454. The outer tube 450 includes one or more ribs 458 that extend across the gap between the first outer wall 452 and the second outer wall 454 such that the ribs 458 define one or more openings 456. In some embodiments a mesh screen (not shown) is positioned over the one or more openings 456. In some embodiments, the mesh screen is co-molded with the outer tube 450. In other embodiments, the filter element 440 does not include a mesh screen positioned over the one or more openings 456. The one or more openings 456 are in fluid providing communication with the outer chamber 428.

The outer tube 450 includes a radial flange 490 that extends radially away from the second outer wall 454. The radial flange 490 is sized to contact the annular flange 434 such that the filter element 440 is prevented from moving relative to the cover 404.

The outer tube 450 also includes an outer tube sealing channel 495. The outer tube sealing channel 498 is disposed proximate the second end 422 of the filtration system 400 and on an outer surface of the second outer wall 454. The outer tube sealing channel 498 is configured to receive a sealing member 496 (e.g., O-ring, gasket, etc.). The sealing member 496 is configured to engage the outer tube sealing channel 495 and the flange sealing surface 437 to form a seal therebetween.

The outer tube 450 also includes one or more outer tube threads 498. In the embodiment shown in FIGS. 6 and 7 the outer tube threads 498 are external threads disposed on an outer surface of the second outer wall 454. In other embodiments, the outer tube threads 498 may be internal threads disposed on an inner surface of the second outer wall 454. The outer tube threads 498 are configured to engage the cover flange threads 436 thereby coupling the filter element 440 to the cover 404.

In some embodiments, the first outer wall 452, the second outer wall 454, and the one or more ribs 458 are formed as a single monolithic part. In other embodiments, the first outer wall 452, the second outer wall 454, and the one or more ribs 458 are separate pieces, and the first outer wall 452 is coupled to the one or more ribs 458 and the second outer wall 454 is coupled to the one or more ribs (e.g., by an ultrasonic welding process or other suitable process).

The first endplate 460 is disposed proximate the first end 421 of the filtration system 400. The first endplate 460 is substantially similar to or the same as the first endplate 160 described herein with respect to FIG. 2. For example, the first endplate 460 includes a first endplate end wall 462 that defines one or more first endplate outer openings 464. The first endplate outer openings 464 enable fluid communication between the first chamber 445 and the outer tube 450, or, more specifically, the chamber 459.

The first endplate 460 also includes a first endplate side wall 466. The first endplate side wall 466 extends axially away from the first endplate end wall 462 and away from the second endplate 480. The first endplate side wall 466 extends around a periphery of the first endplate end wall 462. The first endplate 460 also includes a first endplate sealing channel 468 that is disposed on an outer surface of the first endplate side wall 466. The first endplate sealing channel 468 is configured to receive a first endplate sealing member 469 therein.

The first endplate 460 also includes a first outer mounting portion 470 that is defined by the first endplate end wall 462 and the first endplate side wall 466. The first outer mounting portion 470 is configured to receive a portion of the first outer wall 452 such that the first outer wall 452 is coupled to the first endplate 460.

The first endplate 460 also includes a first endplate center wall 472. The first endplate center wall 472 is disposed within an inner edge of the first endplate end wall 462. The first endplate center wall 472 extends axially away from the first endplate end wall 462 and away from the second endplate 480. In some embodiments, the first endplate center wall 472 defines a first endplate center opening 476. The first endplate 460 is coupled to the center tube 442 such that the first endplate center opening 476 enables fluid communication between the first chamber 445 and the center tube 442.

In some embodiments, a screen 478 is positioned over the one or more first endplate outer openings 464. In some embodiments, the screen 478 is co-molded with the first endplate 460. In other embodiments, the first endplate 460 does not include a screen positioned over the one or more first endplate outer openings 464.

The second endplate 480 is disposed proximate the second end 422 of the filtration system 400. The second endplate 480 includes a second endplate end wall 481. The second endplate end wall 481 defines one or more second endplate outer openings 482 that enable fluid communication between the second chamber 447 and the outer tube 450, or, more specifically, the fluid path defined between the center tube 442 and the outer tube 450 (e.g., the chamber 459).

The second endplate 480 also includes a second endplate center wall 483. The second endplate center wall 483 is disposed within an inner edge of the second endplate end wall 481. The second endplate center wall 483 extends axially away from the second endplate end wall 481 and away from the first endplate 460. In some embodiments, the second endplate center wall 483 includes a second inner mounting portion 484. The second inner mounting portion 484 is configured to receive a portion of the center tube 442 such that the center tube 442 is coupled to the second endplate 480. The second endplate center wall 483 defines a second endplate center opening 485 that is configured to enable fluid communication between the second chamber 447 and the center tube 442.

The second endplate 480 also includes a second endplate side wall 486. The second endplate side wall 486 extends axially away from the second endplate end wall 481 and away from the first endplate 460. The second endplate side wall 486 extends around a periphery of the second endplate end wall 481. The second endplate 480 also includes a second endplate flange 487 that extends radially away from the second endplate side wall 486. The second endplate flange 487 extends between the cover 408 and a portion of the outer tube 450 (e.g., the axial flange 498).

The second endplate 480 also includes a second outer mounting portion 488. The second endplate side wall 486 and the second endplate flange 487 cooperate to define the second outer mounting portion 488. The second outer mounting portion 488 is configured to receive a portion of the second outer wall 454 such that the second outer wall 454 is coupled to the second endplate 480.

The second endplate 480 also includes a rib 489 that extends radially away from the second endplate center wall 483 and axially away from the second endplate center opening 485 and towards the cover end wall 408. The rib 489 contacts the axial flange 448 of the center tube 442 such that the center tube 442 is prevented from moving relative to the filter element 440.

In some embodiments, a screen 478 is positioned over the one or more second endplate outer openings 482. In some embodiments, the screen 478 is co-molded with the second endplate 480. In other embodiments, the second endplate 480 does not include a screen positioned over the one or more second endplate outer openings 482.

The filter element 440 also includes a first resin bed 492. The first resin bed 492 is formed on the first outer wall 452 between an inner surface of the first outer wall 452 and an outer surface of the center tube 442. The first resin bed 492 extends between the first endplate 460 and the one or more openings 456. The first resin bed 492 is configured to filter the fluid passing through the outer tube 450. More specifically, the first resin bed 492 is configured to deionize the fluid flowing from the first endplate 460, through the outer tube 450, and flowing out of the one or more openings 456.

The filter element 440 also includes a second resin bed 494. The second resin bed 494 is formed on the second outer wall 454 between an inner surface of the second outer wall 454 and an outer surface of the center tube 442. The second resin bed 494 extends between the second endplate 480 and the one or more openings 456. The second resin bed 494 is configured to filter the fluid passing through the outer tube 450. More specifically, the second resin bed 494 is configured to deionize the fluid flowing from the second endplate 480, through the outer tube 450, and flowing out of the one or more openings 456.

The one or more first endplate outer openings 464 are structured to direct a fluid in a first direction from the first chamber 445 towards the first resin bed 492. The one or more second endplate outer openings 482 are structured to direct the fluid in a second direction, opposite the first direction, from the second chamber 447 towards the second resin bed 494.

In some embodiments, the first resin bed 492 and the second resin bed 494 are formed as a single, unitary, resin bed, such that the filter element 440 includes a single, contiguous, resin bed. In these embodiments, the “first resin bed” 492 refers to a first portion of the resin bed that is defined between the first endplate 460 and the one or more openings 456, and the “second resin bed” 494 refers to a second portion of the resin bed that is defined between the second endplate 480 and the one or more openings 456.

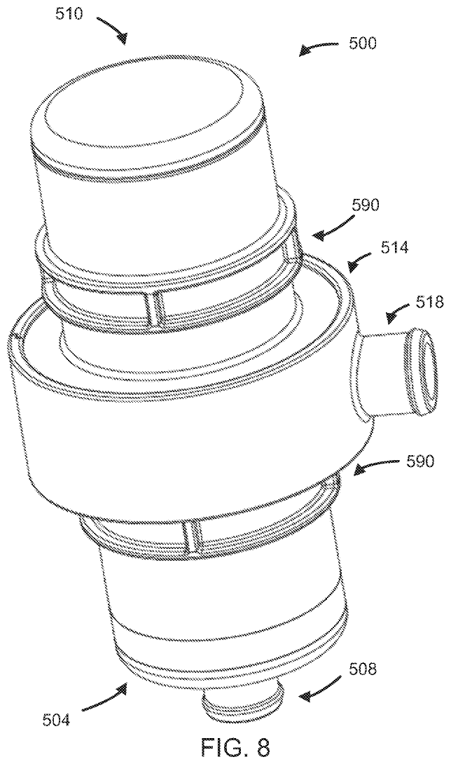

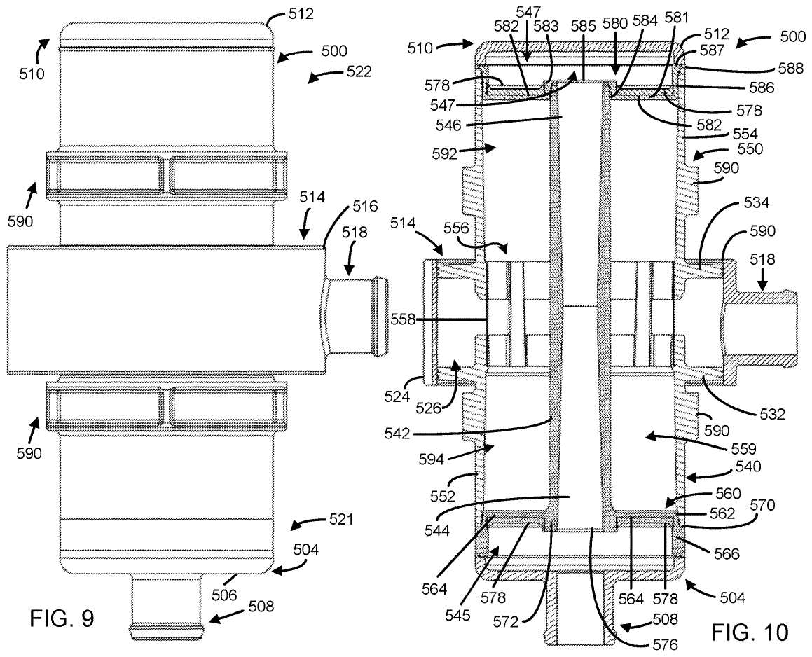

Referring now to FIGS. 8-10 various views of a filtration system 500 are shown, according to an example embodiment. The filtration system 500 is configured to receive an ionized fluid (e.g., coolant, etc.), filter the fluid by a deionizing process, and provide the deionized fluid to a downstream device, such as a fuel cell stack. The filtration system 500 includes a first endcap 504, a second endcap 510, a central cap 514, and a filter element 540. It should be understood that the filtration system 500 may include more or fewer components than as shown in FIGS. 8-10. In the embodiment shown, the first endcap 504, the second endcap 510, and the central cap 514 are permanently coupled to the filter element 540 (e.g., by an ultrasonic welding process or other suitable process).

The first endcap 504 is disposed at a first end 521 of the filtration system 500. The first endcap 504 includes a first endcap wall 506. The first endcap 504 also includes a first port 508 that extends through the first endcap wall 506. In the embodiment shown in FIGS. 8-10, the first port 508 is configured as an inlet port. The first port 508 is in fluid receiving communication with an upstream device, such as a pump, a fluid reservoir, etc. The first port 508 is in fluid providing communication with the filter element 540. As shown, the first port 508 extends in an axial direction.

The second endcap 510 is disposed at a second end 522 of the filtration system 500, opposite the first end 521 of the filtration system 500. The second endcap 510 includes a second endcap wall 512.

The central cap 514 is disposed between the firs end 521 and the second end 522. The central cap 514 includes an annular wall 516 that extends around the filter element 540. The central cap 514 includes a second port 518 that extends through the annular wall 516. The second port 518 is configured as an outlet port. The second port 518 is in fluid receiving communication with the filter element 540. The second port 518 is in fluid providing communication with a downstream device, such as a pump, a fluid reservoir, etc. As shown, the second port 518 extends in a radial direction.

The filter element 540 includes a center tube 542, an outer tube 550, a first endplate 560, and a second endplate 580. A first chamber 545 is defined between the filter element 540 and the first endcap 504. A second chamber 547 is defined between the filter element 540 and the second endcap 510. A third chamber 526 is defined between the central cap 514 and the filter element 540.

The center tube 542 is a substantially hollow tube that allows a fluid to flow therethrough. The center tube 542 has a first end 544 proximate the first end 521 of the filtration system 500. The first end 544 of the center tube 542 is in fluid receiving communication with a first chamber 545. The first chamber 545 is defined between the first endplate 560 and the fist endcap 504. The first chamber 545 is in fluid receiving communication with the first port 508. The center tube 542 has a second end 546 proximate the second end 522 of the filtration system 500, opposite the first end 544. The second end 546 of the center tube 542 is in fluid providing communication with a second chamber 547. The second chamber 547 is defined between the second endplate 580 and the second endcap 510. The second chamber 547 is in fluid receiving communication with the center tube 542.

The outer tube 550 is a substantially hollow tube. The outer tube 550 is disposed around an outside of the center tube 542 such that a chamber 559 defined between the center tube 542 and the outer tube 550. More specifically, the chamber 559 is defined between the center tube 542, the outer tube 550, the first endplate 560, and the second endplate 580. The outer tube 550 at least partially defines an outside surface of the filtration system 500.

The outer tube 550 includes a first outer wall 552 and a second outer wall 554. A gap is defined between the first outer wall 552 and the second outer wall 554. The outer tube 550 includes one or more ribs 558 that extend across the gap between the first outer wall 552 and the second outer wall 554 such that the ribs 558 define one or more openings 556. In some embodiments a mesh screen (not shown) is positioned over the one or more openings 556. In some embodiments, the mesh screen is co-molded with the outer tube 550. In other embodiments, the filter element 540 does not include a mesh screen positioned over the one or more openings 556. The one or more openings 556 are in fluid providing communication with the third chamber 526.

In some embodiments, the first outer wall 552, the second outer wall 554, and the one or more ribs 558 are formed as a single monolithic part. In other embodiments, the first outer wall 552, the second outer wall 554, and the one or more ribs 558 are separate pieces, and the first outer wall 552 is coupled to the one or more ribs 558 and the second outer wall 554 is coupled to the one or more ribs (e.g., by an ultrasonic welding process or other suitable process).

The outer tube 550 includes a first flange 532 that extends radially away from the first outer wall 552. The first flange 532 extends around an outer periphery of the outer tube 550 proximate the one or more ribs 558. The outer tube 550 also includes a second flange 534 that extends radially away from the second outer wall 554. The second flange 534 extends around an outer periphery of the outer tube 550 proximate the one or more ribs 558. The central cap 514 is coupled to the filter element 540 at the first flange 532 and the second flange 534. More specifically, the central cap 514 is coupled to outer (e.g., radially outer) surfaces of the first flange 532 and the second flange 534. When the central cap 514 is coupled to the first flange 532 and the second flange 534, the central cap 514, the first flange 532, and the second flange 534 cooperate to define the third chamber 526.

The outer tube 550 also includes one or more mounting portions 590. In the embodiment shown in FIGS. 8-10, a first mounting portion 590 extends around an outside of the first outer wall 552 and a second mounting portion 590 extends around an outside of the second outer wall 554. The one or more mounting portions are configured to enable coupling the filtration system 500 to a mounting surface (e.g., on a vehicle, on a frame, etc.).

The first endplate 560 is disposed proximate the first end 521 of the filtration system 500. The first endplate 560 includes a first endplate end wall 562. The first endplate end wall 562 defines one or more first endplate outer openings 564 that enable fluid communication between the first chamber 545 and the outer tube 550, or, more specifically, the chamber 559. The first endplate 560 also includes a first endplate side wall 566. The first endplate side wall 566 extends axially away from the first endplate end wall 562 and away from the second endplate 580. The first endplate side wall 566 extends around a periphery of the first endplate end wall 562. The first endplate side wall 566 extends between the first outer wall 552 and the first endcap wall 506.

The first endplate 560 also includes a first outer mounting portion 570 that is defined by the first endplate end wall 562 and the first endplate side wall 566. The first outer mounting portion 570 is configured to receive a portion of the first outer wall 552 such that the first outer wall 552 is coupled to the first endplate 560.

The first endplate 560 also includes a first endplate center wall 572. The first endplate center wall 572 is disposed within an inner edge of the first endplate end wall 562. The first endplate center wall 572 extends axially away from the first endplate end wall 562 and away from the second endplate 580. The first endplate center wall 572 defines a first endplate center opening 576. The first endplate 560 is coupled to the center tube 542 such that the opening 576 enables fluid communication between the first chamber 545 and the center tube 542.

In some embodiments, a screen 578 is positioned over the one or more first endplate outer openings 564. In some embodiments, the screen 578 is co-molded with the first endplate 560. In other embodiments, the first endplate 560 does not include a screen positioned over the one or more first endplate outer openings 564.

The second endplate 580 is disposed proximate the second end 522 of the filtration system 500. The second endplate 580 includes a second endplate end wall 581. The second endplate end wall 581 defines one or more second endplate outer openings 582 that enable fluid communication between the second chamber 547 and the outer tube 550, or, more specifically, the fluid path defined between the inner tube 542 and the outer tube 550 (e.g., the chamber 559).

The second endplate 580 also includes a second endplate center wall 583. The second endplate center wall 583 is disposed within an inner edge of the second endplate end wall 581. The second endplate center wall 583 extends axially away from the second endplate end wall 581 and away from the first endplate 560. In some embodiments, the second endplate center wall 583 includes a second inner mounting portion 584. The second inner mounting portion 584 is configured to receive a portion of the center tube 542 such that the center tube 542 is coupled to the second endplate 580. The second endplate center wall 583 defines a second endplate center opening 585 that is configured to enable fluid communication between the second chamber 547 and the center tube 542.

The second endplate 580 also includes a second endplate side wall 586. The second endplate side wall 586 extends axially away from the second endplate end wall 581 and away from the first endplate 560. The second endplate side wall 586 extends around a periphery of the second endplate end wall 581. The second endplate 580 also includes a second endplate flange 587 that extends radially away from the second endplate side wall 586. The second endplate flange 587 extends between the second outer wall 554 and the second endcap wall 512.

The second endplate 580 also includes a second outer mounting portion 588. The second endplate side wall 586 and the second endplate flange 587 cooperate to define the second outer mounting portion 588. The second outer mounting portion 588 is configured to receive a portion of the second outer wall 554 such that the second outer wall 554 is coupled to the second endplate 580.

In some embodiments, a screen 578 is positioned over the one or more second endplate outer openings 582. In some embodiments, the screen 578 is co-molded with the second endplate 580. In other embodiments, the second endplate 580 does not include a screen positioned over the one or more second endplate outer openings 582.

The filter element 540 also includes a first resin bed 592. The first resin bed 592 is formed on the first outer wall 552 between an inner surface of the first outer wall 552 and an outer surface of the center tube 542. The first resin bed 592 extends between the first endplate 560 and the one or more openings 556. The first resin bed 592 is configured to filter the fluid passing through the outer tube 550. More specifically, the first resin bed 592 is configured to deionize the fluid flowing from the first endplate 560, through the outer tube 550, and flowing out of the one or more openings 556.

The filter element 540 also includes a second resin bed 594. The second resin bed 594 is formed on the second outer wall 554 between an inner surface of the second outer wall 554 and an outer surface of the center tube 542. The second resin bed 594 extends between the second endplate 580 and the one or more openings 556. The second resin bed 594 is configured to filter the fluid passing through the outer tube 550. More specifically, the second resin bed 594 is configured to deionize the fluid flowing from the second endplate 580, through the outer tube 550, and flowing out of the one or more openings 556.

The one or more first endplate outer openings 564 are structured to direct a fluid in a first direction from the first chamber 545 towards the first resin bed 592. The one or more second endplate outer openings 582 are structured to direct the fluid in a second direction, opposite the first direction, from the second chamber 547 towards the second resin bed 594.

In some embodiments, the first resin bed 592 and the second resin bed 594 are formed as a single, unitary, resin bed, such that the filter element 540 includes a single, contiguous, resin bed. In these embodiments, the “first resin bed” 592 refers to a first portion of the resin bed that is defined between the first endplate 560 and the one or more openings 556, and the “second resin bed” 594 refers to a second portion of the resin bed that is defined between the second endplate 580 and the one or more openings 556.

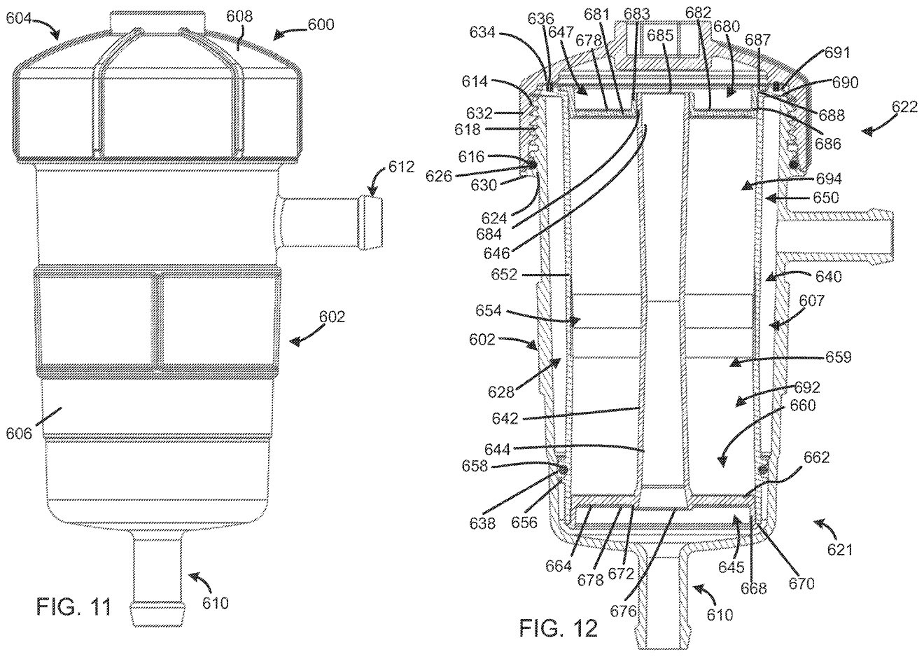

Now referring to FIGS. 11 and 12, a side view of a filtration system 600 and a side-sectional view of the filtration system 600 are shown, according to an example embodiment. The filtration system 600 is configured to receive an ionized fluid (e.g., coolant, etc.), filter the fluid by a deionizing process, and provide the deionized fluid to a downstream device, such as a fuel cell stack. As shown, the filtration system 600 includes a shell 602, a cover 604, and a filter element 640. In some embodiments, the shell 602 and the filter element 640 cooperate to define a filter cartridge. In other embodiments, the cover 604 and the filter element 640 cooperate to define the filter cartridge. It should be understood that the filtration system 600 may include more or fewer components than as shown in FIGS. 11 and 12.

The shell 602 includes a shell wall 606. The shell wall 606 at least partially defines an internal volume 607. The shell 606 is configured to receive at least a portion of the filter element 640 therein such that the filter element 640 is at least partially contained within the internal volume 607. The shell 602 also includes a first port 610 and a second port 612. The first port 610 is disposed proximate a first end 621 of the filtration system 600. The second port 612 is disposed between the first end 621 of the filtration system 600 and a second end 622 of the filtration system 600, opposite the first end 621. In the embodiment shown in FIGS. 11 and 12, the first port 610 is configured as an inlet port. The first port 610 is in fluid receiving communication with an upstream device, such as a pump, a fluid reservoir, etc. The first port 610 is in fluid providing communication with the filter element 640. The second port 612 is configured as an outlet port. The second port 612 is in fluid receiving communication with the filter element 640. The second port 612 is in fluid providing communication with a downstream device, such as a pump, a fluid reservoir, etc.

The shell 602 also includes one or more shell threads 614. In the embodiment shown in FIG. 12 the shell threads 614 are external threads disposed on an outer surface of the shell wall 606. In other embodiments, the shell threads 614 may be internal threads disposed on an inside surface of the shell wall 606. The shell threads 614 are configured to engage a portion of the cover 604, as described in greater detail below.

The shell 602 also includes a shell sealing channel 624. The shell sealing channel 624 is disposed proximate the second end 622 of the filtration system 600 and on an outer surface of the shell wall 606. The shell sealing channel 624 is configured to receive a first sealing member 626 (e.g., O-ring, gasket, etc.).

The shell 602 also includes a shell radial flange 630. The shell radial flange 630 extends radially away from the shell wall 606. The shell radial flange 630 is configured to limit the movement of the cover 604 relative to the shell 602, as described in greater detail below.

The shell 602 includes a shell sealing surface 638. The shell sealing surface 638 is disposed on an inner surface of the shell wall 606 and is directed towards the filter element 640. The shell sealing surface 638 is configured to engage a sealing member 658, as described in greater detail below.

The cover 604 includes a cover end wall 608. The cover 604 also includes a cover side wall 632 that extends axially away from the cover end wall 608 and towards the shell 602. The cover side wall 632 includes a side wall sealing surface 616. The sealing member 626 is configured to engage the side wall sealing surface 616 to form a seal between the cover 604 and the shell 602. When the cover 604 is coupled to the shell 602, the sealing member 626 is compressed in an axial direction and a radial direction. The axial and radial compression of the sealing member 626 enables the cover 604 to be coupled to or decoupled from the shell 602 with less force.

The cover side wall 632 also includes one or more cover threads 618. In the embodiment shown in FIG. 12 the cover threads 618 are internal threads disposed on an inner surface of the cover 604. In other embodiments, the cover threads 618 may be external threads disposed on an outside surface of the cover 604. The cover threads 618 are configured to engage the shell threads 614, thereby coupling the cover 604 to the shell 602. When the cover 604 is coupled to the shell 602, the cover side wall 632 may contact the shell radial flange 630 such that the shell radial flange 630 limits the movement of the cover 604 relative to the shell 602.

The cover end wall 608 defines a cover end wall sealing surface 634. The cover end wall sealing surface 634 is disposed on a bottom surface of the cover end wall 608 and is directed towards the filter element 640. The cover end wall sealing surface 634 is configured to engage a sealing member 636, as described in detail herein.

The filter element 640 is disposed within the internal volume 607 defined by the cover 604 and the shell 602. The filter element 640 includes a center tube 642, an outer tube 650, a first endplate 660, and a second endplate 680. When the filter element 640 is disposed within the internal volume 607, an outer chamber 628 is defined between the filter element 640 and the shell wall 606. The outer chamber 628 is in fluid receiving communication with the filter element 640. The outer chamber 628 is in fluid providing communication with the second port 612.

The center tube 642 is a substantially hollow tube that allows a fluid to flow therethrough. The center tube 642 has a first end 644 proximate the first end 621 of the filtration system 600. The first end 644 of the center tube 642 is in fluid receiving communication with a first chamber 645. The first chamber 645 is defined between the first endplate 660 and the shell wall 606. The first chamber 645 is in fluid receiving communication with the first port 610. The center tube 642 has a second end 646 proximate the second end 622 of the filtration system 600, opposite the first end 644. The second end 646 of the center tube 642 is in fluid providing communication with a second chamber 647. The second chamber 647 is defined between the second endplate 680 and the cover 604. The second chamber 647 is in fluid receiving communication with the center tube 642.

The outer tube 650 is a substantially hollow tube. The outer tube 650 is disposed around an outside of the center tube 642 such that a chamber 659 defined between the center tube 642 and the outer tube 650. More specifically, the chamber 659 is defined between the center tube 642, the outer tube 650, the first endplate 660, and the second endplate 680. The outer tube 650 includes an outer wall 652. The outer tube 650 includes at least one opening 654. The at least one opening 654 extends radially through the outer wall 652 such that a fluid can flow through the opening 654 in a radial direction. In some embodiments a mesh screen (not shown) is positioned over the at least one opening 654. In some embodiments, the mesh screen is co-molded with the outer tube 650. In other embodiments, the filter element 640 does not include a mesh screen positioned over the at least one opening 654. The at least one opening 654 is in fluid providing communication with the outer chamber 628.

The outer tube 650 includes a first outer tube sealing channel 656. The first outer tube sealing channel 656 is disposed on an outer surface of the outer wall 652 and is directed towards the shell wall 606. The first outer tube sealing channel 656 is configured to receive a sealing member 658 (e.g., O-ring, gasket, etc.). The sealing member 658 is configured to engage the first outer tube sealing channel 656 and the shell sealing surface 638 to form a seal therebetween.

The outer tube 650 includes a radial flange 690. The radial flange 690 is disposed proximate the second end 622 of the filtration system 600 and extends radially away from the outer wall 652. The radial flange 690 is sized to contact a top surface of the shell wall 606.

The outer tube 650 includes a second outer tube sealing channel 691. The second outer tube sealing channel 691 is disposed on an outer surface of the radial flange 690 and is directed towards the cover end wall 608. The second outer tube sealing channel 691 is configured to receive a sealing member 636 (e.g., O-ring, gasket, etc.). The sealing member 636 is configured to engage the second outer tube sealing channel 691 and the cover end wall sealing surface 634 to form a seal therebetween.

The first endplate 660 is disposed proximate the first end 621 of the filtration system 600. The first endplate 660 is substantially similar to or the same as the first endplate 160 described herein with respect to FIG. 2. For example, the first endplate 660 includes a first endplate end wall 662 that defines one or more first endplate outer openings 664. The first endplate outer openings 664 enable fluid communication between the first chamber 645 and the outer tube 650, or, more specifically, the chamber 659.

The first endplate 660 also includes a first endplate side wall 668. The first endplate side wall 668 extends axially away from the first endplate end wall 662 and away from the second endplate 680. The first endplate side wall 668 extends around a periphery of the first endplate end wall 662.

The first endplate 660 also includes a first outer mounting portion 670 that is defined by the first endplate end wall 662 and the first endplate side wall 668. The first outer mounting portion 670 is configured to receive a portion of the first outer wall 652 such that the outer wall 652 is coupled to the first endplate 660.

The first endplate 660 also includes a first endplate center wall 672. The first endplate center wall 672 is disposed within an inner edge of the first endplate end wall 662. The first endplate center wall 672 extends axially away from the first endplate end wall 662 and away from the second endplate 680. In some embodiments, the first endplate center wall 672 defines a first endplate center opening 676. The first endplate 660 is coupled to the center tube 642 such that the first endplate center opening 676 enables fluid communication between the first chamber 645 and the center tube 642.

In some embodiments, a screen 678 is positioned over the one or more first endplate outer openings 664. In some embodiments, the screen 678 is co-molded with the first endplate 660. In other embodiments, the first endplate 660 does not include a screen positioned over the one or more first endplate outer openings 664.

The second endplate 680 is disposed proximate the second end 622 of the filtration system 600. The second endplate 680 includes a second endplate end wall 681. The second endplate end wall 681 defines one or more second endplate outer openings 682 that enable fluid communication between the second chamber 647 and the outer tube 650, or, more specifically, the fluid path defined between the center tube 642 and the outer tube 650 (e.g., the chamber 659).

The second endplate 680 also includes a second endplate center wall 683. The second endplate center wall 683 is disposed within an inner edge of the second endplate end wall 681. The second endplate center wall 683 extends axially away from the second endplate end wall 681 and away from the first endplate 660. In some embodiments, the second endplate center wall 683 includes a second inner mounting portion 684. The second inner mounting portion 684 is configured to receive a portion of the center tube 642 such that the center tube 642 is coupled to the second endplate 680. The second endplate center wall 683 defines a second endplate center opening 685 that is configured to enable fluid communication between the second chamber 647 and the center tube 642.

The second endplate 680 also includes a second endplate side wall 686. The second endplate side wall 686 extends axially away from the second endplate end wall 681 and away from the first endplate 660. The second endplate side wall 686 extends around a periphery of the second endplate end wall 681. The second endplate 680 also includes a second endplate flange 687 that extends radially away from the second endplate side wall 686. The second endplate flange 687 extends between the cover 608 and a portion of the outer tube 650 (e.g., the radial flange 690).

The second endplate 680 also includes a second outer mounting portion 688. The second endplate side wall 686 and the second endplate flange 687 cooperate to define the second outer mounting portion 688. The second outer mounting portion 688 is configured to receive a portion of the outer wall 652 such that the outer wall 652 is coupled to the second endplate 680.

In some embodiments, a screen 678 is positioned over the one or more second endplate outer openings 682. In some embodiments, the screen 678 is co-molded with the second endplate 680. In other embodiments, the second endplate 680 does not include a screen positioned over the one or more second endplate outer openings 682.

The filter element 640 also includes a first resin bed 692. The first resin bed 692 is formed on the outer wall 652 between an inner surface of the outer wall 652 and an outer surface of the center tube 642. The first resin bed 692 extends between the first endplate 660 and the at least one opening 654. The first resin bed 692 is configured to filter the fluid passing through the outer tube 650. More specifically, the first resin bed 692 is configured to deionize the fluid flowing from the first endplate 660, through the outer tube 650, and flowing out of the at least one opening 654.

The filter element 640 also includes a second resin bed 694. The second resin bed 694 is formed on the outer wall 652 between an inner surface of the outer wall 652 and an outer surface of the center tube 642. The second resin bed 694 extends between the second endplate 680 and the at least one opening 654. The second resin bed 694 is configured to filter the fluid passing through the outer tube 650. More specifically, the second resin bed 694 is configured to deionize the fluid flowing from the second endplate 680, through the outer tube 650, and flowing out of the at least one opening 654.

The one or more first endplate outer openings 664 are structured to direct a fluid in a first direction from the first chamber 645 towards the first resin bed 692. The one or more second endplate outer openings 682 are structured to direct the fluid in a second direction, opposite the first direction, from the second chamber 647 towards the second resin bed 694.

In some embodiments, the first resin bed 692 and the second resin bed 694 are formed as a single, unitary, resin bed, such that the filter element 640 includes a single, contiguous, resin bed. In these embodiments, the “first resin bed” 692 refers to a first portion of the resin bed that is defined between the first endplate 660 and the one or more openings 656 and the “second resin bed” 694 refers to a second portion of the resin bed that is defined between the second endplate 680 and the one or more openings 656.

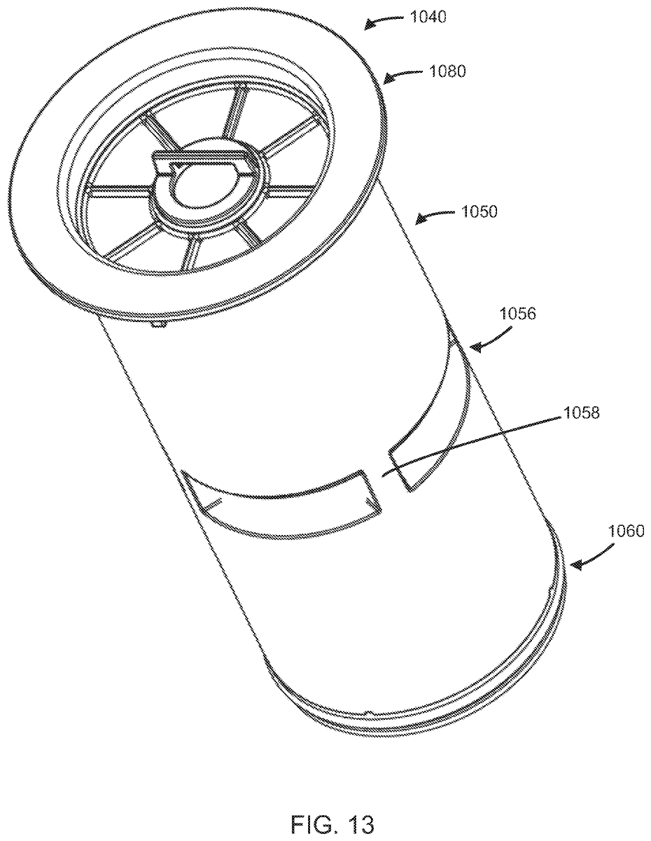

Now referring to FIGS. 13-19, a various views of a filter elements usable in the filtration systems shown in FIGS. 1, 3, 4, 6, 8, and/or 11, is shown according to various example embodiments. In particular, FIG. 13 is a perspective view of a filter element 1040, according to an example embodiment.

The filter element 1040 includes a center tube (not shown), an outer tube 1050, a first endplate 1060, and a second endplate 1080. The center tube, the outer tube 1050, the first endplate 1060, and the second endplate 1080 may be substantially similar to or the same as the center tubes, outer tubes, first endplates, and/or second endplates described above. For example, the outer tube 1050 includes one or more ribs 1058 that define one or more openings 1056.

A ratio of outlet area of outer tube 1050 (e.g., the one or more openings 1056) to combined inlet area of the resin beds (not shown), or, more specifically, outer openings in the first endplate 1060 and/or the second end plate 1080 is between 25% and 75%, inclusive. Advantageously, the outlet area to inlet area ratio may reduce bypass of the fluid and decrease pressure drop across the resin beds.

The openings 1056 of the outer tube 1050 are spaced relative to the first end plate 1060 and/or the second endplate 1080 such that a height of the resin beds remains substantially constant when fluid flows through the filter element 1040. For example, the resin beds may expand or “lift” due to fluid flowing therethrough. The resin beds may contract due to shrinkage effects. A ratio of a first distance defined between the openings 1056 and the first end plate 1060 or defined between the openings 1056 and the second endplate 1080 to a second distance between first end plate 1060 and the second endplate 1080 may be between of 30% and 70%, inclusive.

As described above, during operation, a fluid that flows through the first endplate 1060 and the second endplate 1080 compresses the resin beds. The compression of the resin beds advantageously mitigates against tunnel formation and/or bypass.

It should be understood that the filter element 1040 may be used in any of the filtration systems described herein. For example, the filter element 1040 may be used as shown in FIG. 13 in any of the filtration systems described herein and/or the filter element 1040 may be modified for use in any of the filtration systems described herein.

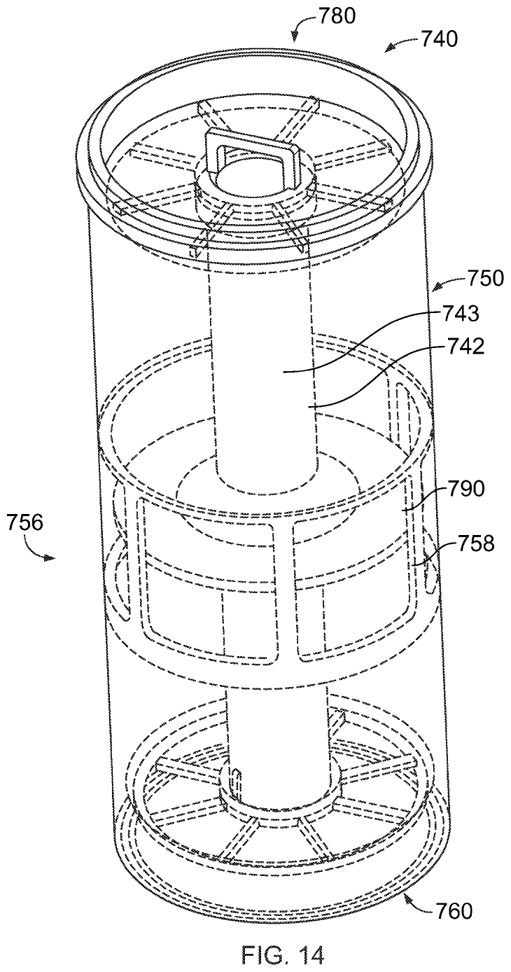

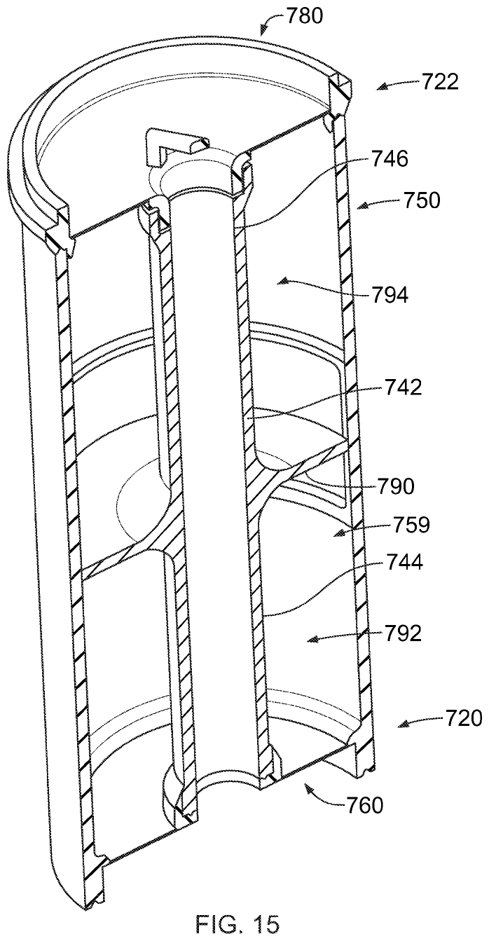

Referring to FIGS. 14-15, various views of a filter element 740 are shown, according to an example embodiment. The filter element 740 includes a center tube 742, an outer tube 750, a first endplate 760 and a second endplate 780. The center tube 742, the outer tube 750, the first endplate 760, and the second endplate 780 may be substantially similar to or the same as the center tubes, outer tubes, first endplates, and/or second endplates described above. For example, the outer tube 750 includes one or more ribs 758 that define one or more openings 756. The outer tube 750 is disposed around an outside of the center tube 742 such that a chamber 759 defined between the center tube 742 and the outer tube 750. More specifically, the chamber 759 is defined between the center tube 742, the outer tube 750, the first endplate 760, and the second endplate 780.

The center tube 742 includes a center tube wall 743. The center tube wall 743 includes a first tube portion 744 disposed at a first end 720 of the filter element 740. The center tube wall 743 includes a second tube portion 746 disposed at a second end 722 of the filter element 740, opposite the first end 720. The center tube 742 also includes a baffle 790 disposed between the first tube portion 744 and the second tube portion 746. The baffle 790 extends from an outer surface of the center tube wall 743 and towards the outer tube 750. More specifically, the baffle 790 extends towards the one or more openings 756 such that the baffle 790 contacts the ribs 758.

The baffle 790 divides the chamber 759 into a first chamber 792 defined between the first endplate 760 and the baffle 790 and a second chamber 794 defined between the second endplate 780 and the baffle 790. The baffle 790 directs fluid that flows into the first chamber 792 and/or into the second chamber 794 to flow out of the filter element 740 via the one or more openings 756.

It should be understood that the filter element 740 may be used in any of the filtration systems described herein. For example, the filter element 740 may be used as shown in FIG. 14 in any of the filtration systems described herein and/or the filter element 740 may be modified for use in any of the filtration systems described herein.

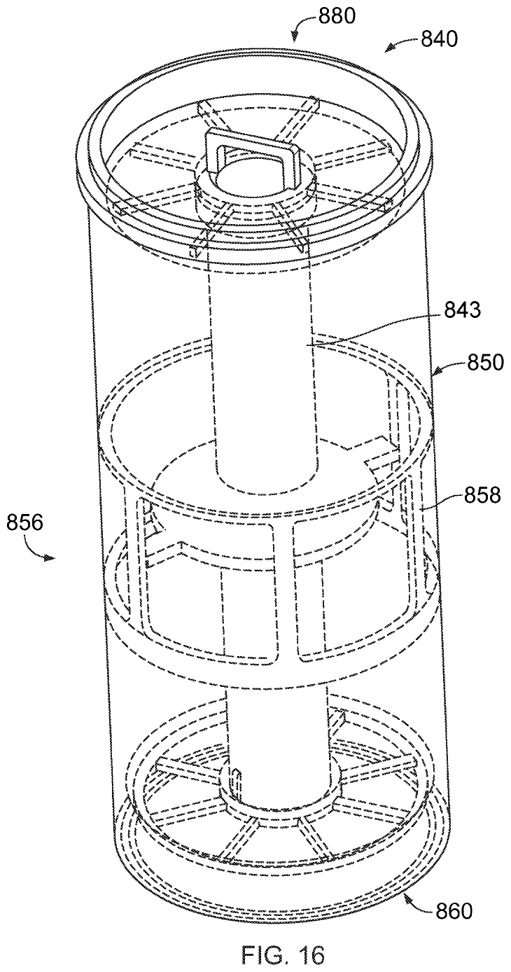

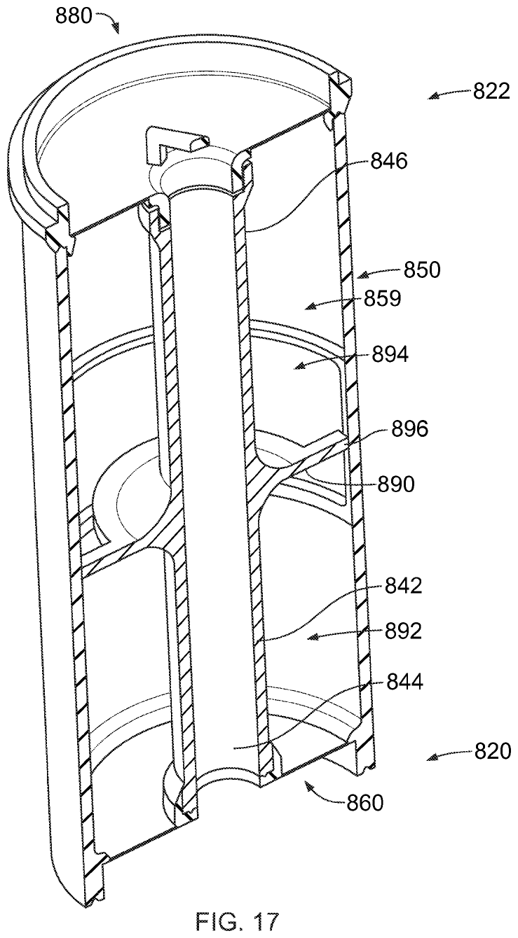

Referring to FIGS. 16-17, various views of a filter element 840 usable in the filtration systems shown in FIGS. 1, 3, 4, 6, 8, and/or 11 are shown, according to an example embodiment. The filter element 840 includes a center tube 842, an outer tube 850, a first endplate 860 and a second endplate 880. The center tube 842, the outer tube 850, the first endplate 860, and the second endplate 880 may be substantially similar to or the same as the center tubes, outer tubes, first endplates, and/or second endplates described above. For example, the outer tube 850 includes one or more ribs 858 that define one or more openings 856. The outer tube 850 is disposed around an outside of the center tube 842 such that a chamber 859 defined between the center tube 842 and the outer tube 850. More specifically, the chamber 859 is defined between the center tube 842, the outer tube 850, the first endplate 860, and the second endplate 880.

The center tube 842 includes a center tube wall 843. The center tube wall 843 includes a first tube portion 844 disposed at a first end 820 of the filter element 840. The center tube wall 843 includes a second tube portion 846 disposed at a second end 822 of the filter element 840, opposite the first end 820. The center tube 842 also includes a baffle 890 disposed between the first tube portion 844 and the second tube portion 846. The baffle 890 extends radially away from an outer surface of the center tube wall 843 and towards the outer tube 850. More specifically, the baffle 890 extends partially towards the one or more openings 856. The center tube 842 also includes one or more flanges 892 that extend radially away from the baffle 890 and towards the one or more ribs 858. In some embodiments, the one or more flanges 892 may contact the one or more ribs 858. In other embodiments, the one or more flanges 892 may extend between the one or more ribs 858 (e.g., within the openings 856).

The baffle 890 at least partially divides the chamber 859 into a first chamber 892 defined between the first endplate 860 and the baffle 890 and a second chamber 894 defined between the second endplate 880 and the baffle 890. The baffle 890 directs fluid that flows into the first chamber 892 and/or into the second chamber 894 to flow out of the filter element 840 via the one or more openings 856.

It should be understood that the filter element 840 may be used in any of the filtration systems described herein. For example, the filter element 840 may be used as shown in FIG. 16 in any of the filtration systems described herein and/or the filter element 840 may be modified for use in any of the filtration systems described herein.

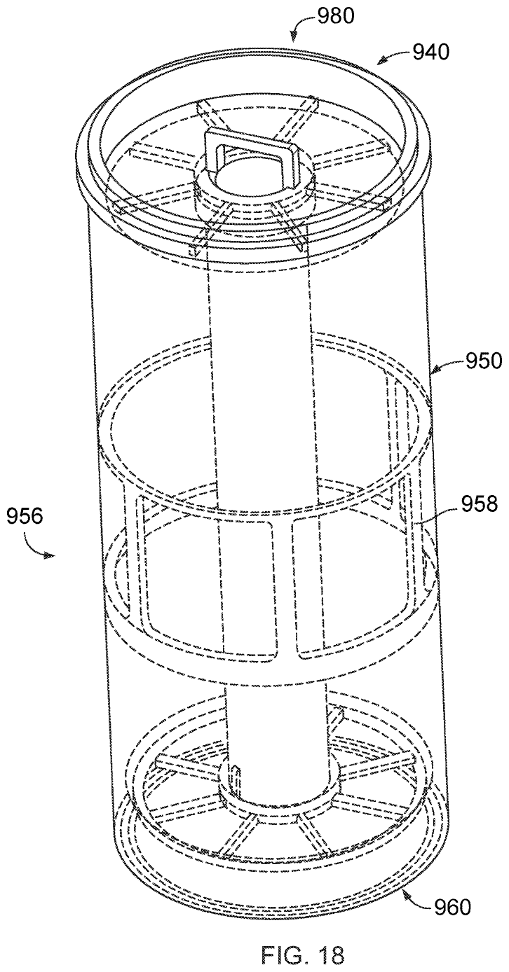

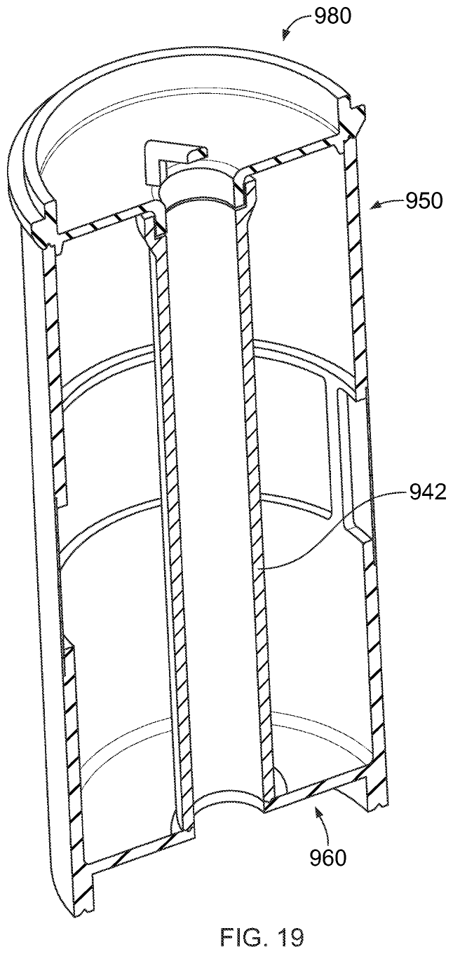

Referring to FIGS. 18-19, various views of a filter element 940 usable in the filtration systems shown in FIGS. 1, 3, 4, 6, 8, and/or 11 are shown, according to an example embodiment. The filter element 940 includes a center tube 942, an outer tube 950, a first endplate 960 and a second endplate 980. The center tube 942, the outer tube 950, the first endplate 960, and the second endplate 980 may be substantially similar to or the same as the center tubes, outer tubes, first endplates, and/or second endplates described above. For example, the outer tube 950 includes one or more ribs 958 that define one or more openings 956.

It should be understood that the filter element 940 may be used in any of the filtration systems described herein. For example, the filter element 940 may be used as shown in FIG. 18 in any of the filtration systems described herein and/or the filter element 940 may be modified for use in any of the filtration systems described herein.

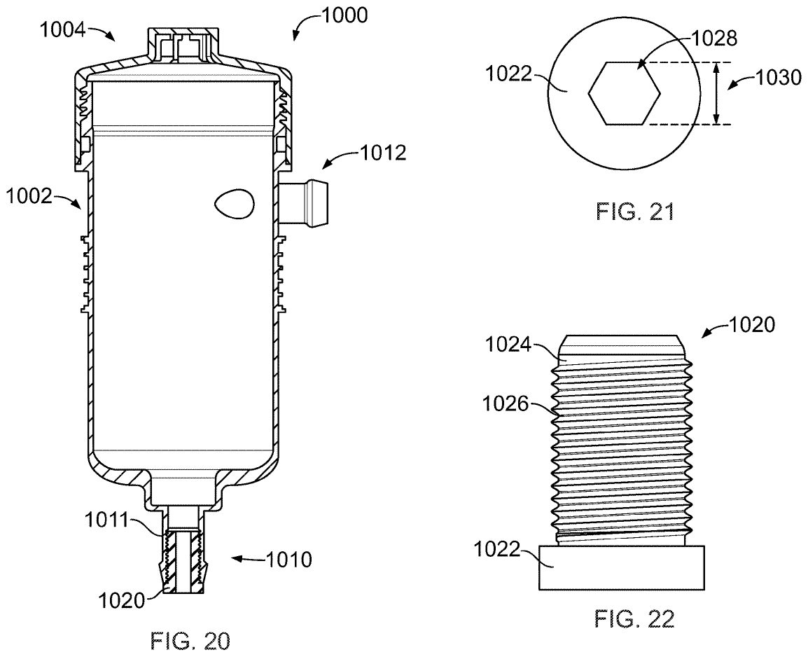

Now referring to FIG. 20 a sectional view of a filter housing 1000 usable with any of the filter elements described herein is shown. The filter housing 1000 includes a shell 1002 and a cover 1004. The cover 1004 is coupled to the shell 1002. The shell 1002 includes a first port 1010 and a second port 1012. A pressure control device 1020 (also referred to herein as a “regulating insert”) is positioned at least partially within the first port 1010.

FIG. 21 is a top view of the pressure control device 1020, and FIG. 22 is a side view of the pressure control device 1020. The pressure control device 1020 includes a head 1022 and a body 1024. The body 1024 extends into the first port 1010. The body 1024 includes one or more threads 1026 that are configured to threadably engage threads 1011 of the first port 1010, such that the pressure control device 1020 is coupled to the first port 1010. The head 1022 and the body 1024 define an opening 1028 that extends through the head 1022 and the body 1024. As shown in FIG. 21, the opening 1028 has a hexagonal cross section with predetermined a diameter 1030. It should be understood that the cross sectional shape of the opening 1028 may be different. The predetermined diameter 1030 may be sized to change the pressure of a fluid flowing through the opening 1028. The opening 1028 enables fluid communication between an upstream side of the pressure control device 1020 and a downstream side of the pressure control device 1020. More specifically, the opening 1028 enables a fluid to flow into the filter housing 1000 via the first port 1010.

In an example operating scenario, and using the filtration system 100 as an example, the filter element 140 is provided in the filtration system 100. A fluid, such as a coolant, enters the filtration system at an inlet (e.g., the first port 110), and the fluid flows into the first chamber 145. At the first chamber 145, the fluid flow is divided between two flow paths. A fluid flowing along a first flow path flows through the outer openings 164 of the first endplate 160, into the first resin bed 192, out of the filter element 140 through the one or more openings 156, and out of the filtration system 100 through the second port 112. A fluid flowing along a second flow path flows through the first endplate center opening 176, into the center tube 142, through the second endplate center opening 185, into the second chamber 147, through the outer openings 182 of the second endplate 180, into the second resin bed 194, out of the filter element 140 through the one or more openings 156, and out of the filtration system 100 through the second port 112.

The fluid flows through the first resin bed 192 and the second resin bed 194 in opposite directions. For example, as shown in FIG. 1 the fluid flows through the first resin bed 192 in an upwards direction, and the fluid flows through the second resin bed 194 in a downwards direction. Advantageously, by allowing the flow to flow through the first resin bed 192 and the second resin bed 194 in opposite directions, the fluid compresses the first resin bed 192 and the second resin bed 194 into each other. The compression of the first resin bed 192 and the second resin bed 194 reduces the overall pressure drop across the filter element 140 for the same amount of resin compared to a conventional axial flow cylindrical DI filter. Further, the compression of the first resin bed 192 and the second resin bed 194 increases the utilization of the first resin bed 192 and the second resin bed 194 by reducing bypass and reducing tunneling formation.

In another example operating scenario, a fluid enters the filtration system 100 at the first port 110. The fluid is divided between a first flow path and a second flow path. The fluid flowing along the first flow path flows into a lower end of the element 140 near the first endplate 160. The fluid flowing along the first flow path travels from the first end of element 140 to the one or more openings 156 positioned on the outer tube 150 and located between the first endplate 160 and the second endplate 180. The fluid flowing along the second flow path flows through the center tube 142 from the first end 144 to the second end 146. At the second end, the fluid flowing along the second flow path flows into the element 140 near the second endplate 180. The fluid flowing along the second flow path flows from the second end of element 140 to the one or more openings 156 positioned on the outer tube 150 and located between the first endplate 160 and the second endplate 180. The fluid is rejoined at or proximate (e.g., upstream or downstream) of the one or more openings 156. The fluid exits the filtration system 100 at the second port 112.

In some embodiments, a length of the outer tube 150 is greater than a length of the center tube 142 such that the fluid flows between the first endplate 160 and the shell 102 near the first port 110 (e.g., at the first chamber 145). Additionally, the fluid may flow between the second endplate 180 and the shell (e.g., at the second chamber 147).

In some embodiments, the length of the outer tube 150 plus and the thickness of either or both the first endplate 160 and second endplate 180 is longer than the center tube 142.

In some embodiments, a fluid enters the filter element 140 near first endplate 160 and near the second endplate 180 in an axial direction (e.g., parallel to the center tube 142) to enter first resin bed 192 and/or second resin bed 194. For example, the fluid enters the filtration system at the first port 110 and is divided between a first flow path and a second flow path. The fluid flowing along the first flow path flows through the outer openings 164 of the first endplate 160 to enter the first resin bed. The fluid flowing along the second flow path flows through first endplate center opening 176, through the center tube 142, through the second endplate center opening 185, and through the outer openings 182 of the second endplate 180 to enter the second resin bed 194.

In some embodiments, a fluid within the filtration system 100 is divided such that a first portion of the fluid enters the element 140 near the first endplate 160 in a radial direction (e.g., perpendicular to the center tube 142), and a second portion of the fluid enters the filter element near the second endplate 180 in a radial direction to enter first resin bed 192 and/or second resin bed 194.

In an example embodiment, the fluid enters the filtration system at the first port 110 and is divided between a first flow path and a second flow path. The fluid flowing along the first flow path flows between the outer tube 150 and the shell 102 and through one or more openings in the outer tube 150 (e.g., one or more openings in the first outer wall 152 between the first endplate 160 and the one or more openings 156) to enter the first resin bed 192. In some embodiments, the first endplate 160 may include one or more openings extending through the first endplate side wall 166 to enable the fluid to flow between the outer tube 150 and the shell 102. The fluid flowing along the second flow path flows through the first endplate center opening 176, through the center tube 142, through the second endplate center opening 185, between the outer tube 150 and the shell 102 and through one or more openings in the outer tube 150 (e.g., one or more openings in the second outer wall 154 between the second endplate 180 and the one or more openings 156) to enter the second resin bed 194. In some embodiments, the second endplate 180 may include one or more openings extending through the second endplate side wall 186 to enable the fluid to flow between the outer tube 150 and the shell 102.

In another example embodiment, the fluid enters the filtration system at the first port 110, flows through the first endplate center opening 176, and flows into the center tube 142. The fluid is divided between a first flow path and a second flow path. The fluid flowing along the first flow path flows through the one or more openings in the center tube at the first end 144 to enter the first resin bed 192. The fluid flowing along the second flow path flows through the one or more openings in the center tube at the second end 146 to enter the second resin bed 194.

It should be understood that the above described methods of filtering a fluid may be used with any of the filtration systems or filter elements described herein. For example, when the filter element 740 is used, when a fluid enters the first chamber 792, the baffle directs the fluid to flow out of the filter element 740 via the one or more openings 756. Similarly, when a fluid enters the second chamber 794, the baffle 790 directs the fluid to flow out of the filter element 740 via the one or more openings 756.

In another embodiment, when the filter element 840 is used, when a fluid enters the first chamber 892, the baffle directs the fluid to flow out of the filter element 840 via the one or more openings 856. Similarly, when a fluid enters the second chamber 894, the baffle 890 directs the fluid to flow out of the filter element 840 via the one or more openings 856.

In another example operating scenario, and using the filtration system 100 as an example, the filter element 140 is a replaceable component, and the shell 102 and/or the cover 104 may be reused. The filter element 140 may be replaced when the resin beds of the filter element 140 are fully utilized (e.g., an amount or concentration of ions in the resin beds is above a predetermined threshold). A method of replacing the filter element 140 may include decoupling the cover 104 from the shell 102, removing the filter element 140 from the filtration system 100, inserting a new filter element 140, and engaging the cover 104 with the shell 102. In some embodiments, the shell 102 and the cover 104 are reused. In other embodiments, at least one of the shell 102 and/or the cover 104 are not reused and are replaced with a new shell 102 and/or a new cover 104, respectively (e.g., before engaging the cover 104 with the shell 102). It should be understood that the above-described method of replacing the filter element 140 may be used with any of the filtration systems or filter elements described herein.

It should be noted that the term “example” as used herein to describe various embodiments is intended to indicate that such embodiments are possible examples, representations, and/or illustrations of possible embodiments (and such term is not intended to connote that such embodiments are necessarily extraordinary or superlative examples).

As utilized herein, the term “substantially” and similar terms are intended to have a broad meaning in harmony with the common and accepted usage by those of ordinary skill in the art to which the subject matter of this disclosure pertains. The term “substantially” as used herein refers to ±10% of the referenced measurement, position, or dimension. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The terms “coupled,” “attached,” and the like as used herein mean the joining of two members directly to one another. Such joining may be stationary (e.g., permanent) or moveable (e.g., removable or releasable).

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the various example embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, various parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various example embodiments without departing from the scope of the concepts presented herein.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

1. A filtration system, comprising:
a shell having an inlet port and an outlet port; and
a filter element disposed within the shell, the filter element comprising:
a first endplate at least partially defining a first chamber;
a second endplate at least partially defining a second chamber;
a center tube coupled to the first endplate and the second endplate, the center tube in fluid receiving communication with the first chamber and fluid providing communication with the second chamber;
an outer tube disposed outside the center tube and coupled to the first endplate and the second endplate, the outer tube comprising one or more openings; and
at least one resin bed disposed between the outer tube and the center tube, the at least one resin bed in fluid receiving communication with one or both of the first chamber and the second chamber.

2. The filtration system of claim 1, wherein:
the first endplate defines one or more first outer openings; and
the second endplate defines one or more second outer openings.

3. The filtration system of claim 2, wherein a ratio of an outlet area of the one or more openings to an inlet area of the one or more first outer openings and the one or more second outer openings is between 0.25 and 0.75, inclusive.

4. The filtration system of claim 2, further comprising:
a screen positioned over the one or more first outer openings.

5. The filtration system of claim 1, wherein a ratio of a first distance between the first endplate and the one or more openings to a second distance between the first endplate and the second endplate is between 0.30 and 0.70.

6. The filtration system of claim 1, further comprising:
a baffle that extends from the center tube towards the outer tube, the baffle at least partially dividing a chamber defined between the first endplate and the second endplate into a first chamber portion defined between the first endplate and the baffle and a second chamber portion defined between the second endplate and the baffle.

7. The filtration system of claim 1, further comprising:
a baffle that extends from the center tube towards the outer tube, the baffle extending between the center tube and the outer tube such that the baffle divides a chamber defined between the first endplate and the second endplate into a first chamber portion defined between the first endplate and the baffle and a second chamber portion.

8. The filtration system of claim 1, wherein the outer tube comprises:
a first outer wall;
a second outer wall, the first outer wall spaced from the second outer wall such that a gap is defined between the first outer wall and the second outer wall; and
one or more ribs extending across the gap between the first outer wall and the second outer wall such that the one or more ribs define the one or more openings.

9. The filtration system of claim 1, further comprising:
a regulating insert disposed within the inlet port, the regulating insert defining an opening enabling fluid communication into the filtration system via the inlet port.

10. A filter element, comprising:
a first endplate at least partially defining a first chamber;
a second endplate at least partially defining a second chamber;
a center tube coupled to the first endplate and the second endplate, the center tube in fluid receiving communication with the first chamber and fluid providing communication with the second chamber;
an outer tube disposed outside the center tube and coupled to the first endplate and the second endplate, the outer tube comprising one or more openings; and
at least one resin bed disposed between the outer tube and the center tube, the at least one resin bed in fluid receiving communication with one or both of the first chamber and the second chamber.

11. The filter element of claim 10, wherein:
the first endplate defines one or more first outer openings; and
the second endplate defines one or more second outer openings.

12. The filter element of claim 11, wherein a ratio of an outlet area of the one or more openings to an inlet area of the one or more first outer openings and the one or more second outer openings is between 0.25 and 0.75, inclusive.

13. The filter element of claim 11, further comprising:
a screen positioned over the one or more first outer openings.

14. The filter element of claim 10, wherein a ratio of a first distance between the first endplate and the one or more openings to a second distance between the first endplate and the second endplate is between 0.30 and 0.70.

15. The filter element of claim 10, further comprising:
a baffle that extends from the center tube towards the outer tube, the baffle at least partially dividing a chamber defined between the first endplate and the second endplate into a first chamber portion defined between the first endplate and the baffle and a second chamber portion defined between the second endplate and the baffle.

16. The filter element of claim 10, further comprising:
a baffle that extends from the center tube towards the outer tube, the baffle extending between the center tube and the outer tube such that the baffle divides a chamber defined between the first endplate and the second endplate into a first chamber portion defined between the first endplate and the baffle and a second chamber portion.

17. The filter element of claim 10, wherein the outer tube comprises:
a first outer wall;
a second outer wall, the first outer wall spaced from the second outer wall such that a gap is defined between the first outer wall and the second outer wall; and
one or more ribs extending across the gap between the first outer wall and the second outer wall such that the one or more ribs define the one or more openings.

18. A method of filtering a fluid, the method comprising:
passing the fluid into a filter element, the filter element comprising a first endplate at least partially defining a first chamber, wherein the fluid is passed into the first chamber;
dividing the fluid between a first flow path and a second flow path, the first flow path defined by first outer openings of the first endplate, the second flow path defined by a center opening of the first endplate, a center tube of the filter element, and second outer openings of a second endplate of the filter element, wherein the center tube is coupled to the first endplate and the second endplate; and
passing the fluid through at least one resin bed, the at least one resin bed in fluid receiving communication with one or both of the first outer openings of the first endplate and the second outer openings of the second endplate.

19. The method of claim 18, further comprising:
passing the fluid through one or more openings of an outer tube of the filter element, wherein the outer tube is coupled to the first endplate and the second endplate.

20. The method of claim 18, wherein
the fluid flowing along the first flow path is passed through the at least one resin bed in a first direction; and
the fluid flowing along the second flow path is passed through the at least one resin bed in a second direction, opposite the first direction.
